(19) United States
(12) Patent Application Publication
(10) Pub. No.: US 2015/0293946 A1
(43) Pub. Date: Oct. 15, 2015

(54) CROSS MODEL DATUM ACCESS WITH SEMANTIC PRESERVATION FOR UNIVERSAL DATABASE

(71) Applicant: City University of Hong Kong, Kowloon (HK)

(72) Inventors: Joseph Fong, Discovery Bay (HK); Herbert Shiu, Lai Chi Kok (HK); Kenneth Wong, Kowloon (HK); Brian Lam, Chai Wan (HK)

(73) Assignee: City University of Hong Kong, Kowloon (HK)

(21) Appl. No.: 14/249,225

(22) Filed: Apr. 9, 2014

(51) Int. Cl. G06F 17/30

(52) U.S. Cl. CPC G06F 17/30294; G06F 17/30941; G06F 17/30595; G06F 17/30731

(57) ABSTRACT

Cross database model datum access with semantic preservation is provided. Data stored in a database under a particular database model can typically be inaccessible or not interoperable with data stored in another database model. A first datum of a first database model is transformed to an interim datum of an interim database model while preserving the data semantics associated with the first datum. Further, the second datum can be transformed into a third datum associated with a third database model, again while preserving the semantics. As such, data in a first silo can be accessed in a different silo while retaining semantic relationships. Further, the use of an interim database can reduce the processing needed to accomplish transforms between a planarity of database models.

### TECHNICAL FIELD

The various embodiments of the subject disclosure relate generally to database information access, e.g., accessing database information across differing database models with datum semantic preservation.

### BACKGROUND

Conventional databases are associated with a plurality of database models. Generally database models are distinct and not interoperable. Data stored in a database under a particular database model can be termed as “siloed data”, e.g., each database model acts as an individual silo such that data stored in one database silo is typically not readily accessible or interoperable with data stored in another database silo. Accordingly, a database management system (DBMS) associated with a database silo, e.g., data stored under a first database model, is generally not interoperable with another database management system associated with another database silo, e.g., data stored under a second database model. This can limit the exchange of information stored in a database where those desiring to access the information are not employing a database management system associated with the database model related to the information.

In another aspect, conventional database silos can constrain users of database management systems within a legacy database silo, e.g., it can be difficult or expensive to migrate to another database management system. This constraint to a legacy database model can, among other considerations, be associated with loss of data semantic information in migrating data to another database model, training users to use a new database management package, expenditures associated with new equipment or systems that can be necessary to operate within a new database model, etc. Further, even where the legacy database model is sufficient for the associated entity, as the legacy database model ages, other entities may employ newer and incompatible database models such that the legacy database model entity is forced to upgrade or risk being unable to partner with newer entities. As an example, a first company can be using a legacy database environment that employs an antiquated database model that is sufficient for the first company's needs. However, where the first company wants to interact with a new company that uses a newer database environment employing a newer database model, the two database models can fail to interoperate. As such, the first company can be forced to upgrade to the newer data model and can incur costs associated with retraining their employees to use the new database model, hiring new employees familiar with the new database model, rebuilding the data and semantics of the antiquated database into the newer database at the risk of losing data or data relationships, purchase of new hardware or software associated with the newer data model, etc. Moreover, as database models continue to evolve, these costs can be incurred repeatedly with each need to change to another database model.

Additionally, even where a database environment is relatively modern, it can be incompatible with other relatively modern database silos. The plurality of database silos in itself can be an impediment to sharing data among them. As an example, where a first company employs a first database associated with a first database model, a second company employs a second data model for their data, and a third company employs a third data model for their data, sharing of data across the three data silos can be impractical or impossible. Where the first company purchase the second company, incorporating the second company's data can be problematic, e.g., it can require rewriting the data into the first data model at the risk of losing data or semantics. Alternatively, the first company can operate the two databases separately but are then internally faced with the incongruences of the two databases, bear the costs associated with operating or maintaining two separate databases, etc. Further, the first company, even with access to the first and second databases, still can face serious challenges with sharing data with the third company.

### SUMMARY

The following presents a simplified summary of the various embodiments of the subject disclosure in order to provide a basic understanding of some aspects described herein. This summary is not an extensive overview of the disclosed subject matter. It is intended to neither identify key or critical elements of the disclosed subject matter nor delineate the scope of the subject various embodiments of the subject disclosure. Its sole purpose is to present some concepts of the disclosed subject matter in a simplified form as a prelude to the more detailed description that is presented later.

The database management systems (DBMSs) of various data models have proliferated into many companies and, over time, have become legacy databases within the companies. However, there is a need to access these legacy databases, e.g., for mass information transmission associated with e-commerce, etc. Legacy databases, e.g., conventional databases, can be associated with a plurality of database models, e.g., database silos. These database silos can be distinct and fail to interoperate without significant costs or loss of data or data semantic information. Siloed data, e.g., data within a database model acts is typically only readily accessible or interoperable within that database model and not with data stored in another database silo, can limit the exchange of information where those desiring to access the information are not employing a related DBMS.

Further, writing legacy data into another database model can generally be associated with risks, such as data loss, semantic information loss, increased expense, support of multiple database environments, etc. As an example, most XML (Extensible Model Language) database management systems can translate a limited set of designated legacy databases into an XML document, however, the translation is typically without data semantic constraint consideration for the legacy database models. This can be insufficient to meet translation requirements, e.g., loss of some, or all, semantic information can degrade the value of the data. Furthermore, the risk of such loss can force operation of two production database systems, the legacy database and the new database, e.g., a legacy database for internal data processing and a replicate XML document for external computing, such as sharing data with other DBMSs across the internet.

Providing cross model datum access with semantic preservation, such as by employing an open universal database gateway (OUDG) as disclosed herein, can capture the data semantics, e.g., cardinality, is-a relationships, generalization, aggregation, etc., of a first legacy database in a flattened XML document. This flattened XML document comprising a datum and related semantic information, can be shared, e.g., transmitted, stored, etc., with another database or DBMS related to another database model. This example OUDG can transform a legacy database to a flattened XML model which can then be transformed to another database under a different database model while preserving data semantics. As a result, users can access each other's databases via the example flattened XML document. This can let users apply their own familiar query language to access the other databases, for example, an user can use SQL (relational database language) to access an object-oriented database, a network database, or a XML database. Similarly, a user can, for example, use OQL (object-oriented database language), IDMS (network database language), or XQuery (XML database language) to access data in other database silos. Furthermore, the example of generating a flattened XML documents as a replicate of first database with preservation of the first database, allow the continued use of the first database in a transparent manner, e.g., without additional expense, training, equipment, etc. Moreover, as the first database is updated, the XML document can be updated allowing the external facing XML document to remain up to date with the internal facing first database.

An embodiment of the presently disclosed subject matter can include a system having a memory and processor that executes instructions to receive information related to a first data store. The system can also determine semantic information related to a datum of the first data store. The system can convert the datum into a second datum associated with an interim data store, wherein the conversion preserves the semantic information. The conversion can be based on the information related to the first data store and the semantic information.

In another embodiment, the disclosed subject matter can be in the form of a method. The method can include receiving first information comprising semantic information describing a data relationship related to a first datum which is associated with a first data store. The method can also comprise receiving the first datum. The method includes translating the first datum into a devolved datum associated with an intermediate data store while maintaining the aforementioned data relationship in the intermediate data store. The translating can be based on the first information

In a further embodiment, the disclosed subject matter can be in the form of computer-executable instructions stored on a non-transitory computer-readable storage medium. Execution of the computer-executable instructions can include receiving information related to a first data store, wherein the information comprises data semantic information describing a data relationship associated with the first data store. Further, execution can include receiving a first datum associated with the first data store and adapting the first datum into a second datum associated with a second data store, wherein the adapting the first datum preserves the data relationship described by the data semantic information and is based on the information related to the first data store. Moreover, the execution of the instructions causes adapting the second datum associated with the second data store into a third datum associated with a third data store, wherein the adapting the second datum preserves the data relationship described by the data semantic information and is based on information related to the second data store.

In an additional embodiment, the disclosed subject matter can be a system having a means for receiving a first datum associated with the first data store and a means for adapting the first datum into a second datum associated with a second data store, based on information related to the first data store, wherein the adapting the first datum preserving data semantics associated with a cardinality, an is-a relationship, a generalization relationship, or an aggregation relationship. Further, the system can include a means for adapting the second datum associated with the second data store into a third datum associated with a third data store, based on the information related to the second data store, wherein the adapting the second datum preserves data semantics associated with the cardinality, the is-a relationship, the generalization relationship, or the aggregation relationship.

The following description and the annexed drawings set forth in detail certain illustrative aspects of the disclosed subject matter. These aspects are indicative, however, of but a few of the various ways in which the principles of the various embodiments of the subject disclosure can be employed and the disclosed subject matter is intended to include all such aspects and their equivalents. Other advantages and distinctive features of the disclosed subject matter will become apparent from the following detailed description of the various embodiments of the subject disclosure when considered in conjunction with the drawings.

### BRIEF DESCRIPTION OF THE DRAWINGS

FIG. 1 is a diagram of a system that can facilitate cross model datum access with semantic preservation in accordance with an aspect of the subject matter disclosed herein.

FIG. 2 is a diagram that illustrates cross model datum access with semantic preservation between a plurality of different database models in accordance with an aspect of the disclosed subject matter.

FIG. 3 is a diagram illustrating cross model datum access with semantic preservation with a one-to-many cardinality semantic in accordance with an aspect of the disclosed subject matter.

FIG. 4 is a diagram illustrating cross model datum access with semantic preservation with a many-to-many cardinality semantic in accordance with an aspect of the disclosed subject matter.

FIG. 5 is a diagram illustrating cross model datum access with semantic preservation with an is-a relationship semantic in accordance with an aspect of the disclosed subject matter.

FIG. 6 is a diagram illustrating cross model datum access with semantic preservation with a generalization semantic in accordance with an aspect of the disclosed subject matter.

FIG. 7 is a diagram illustrating cross model datum access with semantic preservation with an aggregation semantic in accordance with an aspect of the disclosed subject matter.

FIG. 8 is a diagram illustrating aspects of cross model datum access with semantic preservation for several semantics in a flattened XML scheme in accordance with an aspect of the disclosed subject matter.

FIG. 9 is a diagram illustrating aspects of cross model datum access with semantic preservation for several additional semantics in a flattened XML scheme in accordance with an aspect of the disclosed subject matter.

FIG. 10 illustrates an exemplary system that can facilitate cross model datum access with semantic preservation based on datum modification information in accordance with an aspect of the disclosed subject matter.

FIG. 11 is a diagram of a system that can facilitate bidirectional cross model datum access with semantic preservation in accordance with an aspect of the disclosed subject matter.

FIG. 12 is a diagram of a system that can facilitate cross model datum access with semantic preservation employing an interim database component in accordance with an aspect of the disclosed subject matter.

FIG. 13 illustrates an example system that can facilitate cross model datum access with semantic preservation employing a flattened XML scheme and flattened XML document in accordance with an aspect of the disclosed subject matter.

FIG. 14 illustrates a method that facilitates cross model datum access with semantic preservation in accordance with an aspect of the disclosed subject matter.

FIG. 15 illustrates a method that facilitates cross model datum access with semantic preservation, based on a determined change, in accordance with an aspect of the disclosed subject matter.

FIG. 16 depicts a method that facilitates continuous cross model datum access with semantic preservation in accordance with an aspect of the disclosed subject matter.

FIG. 17 illustrates a block diagram of an exemplary electronic device that can facilitate cross model datum access with semantic preservation in accordance with an aspect of the disclosed subject matter.

### DETAILED DESCRIPTION

The presently disclosed subject matter provides cross model datum access with semantic preservation. In an aspect, conventional databases can be associated with a plurality of database models, e.g., database silos, that are generally incompatible. Data stored in a database under a particular database model can typically be inaccessible or not interoperable with data stored in another database model. Accordingly, a database management system (DBMS) associated with a database silo, e.g., data stored under a first database model, may not be interoperable with another database management system associated with another database silo, e.g., data stored under a second database model. These aspects of conventional database environments, systems, and techniques, can limit the exchange of information stored in a database. This can constrain users of database management systems within a legacy database silo. Sharing of data between different database silos can be associated with loss of data semantic information in migrating data to another database model, training users to use a new database management package, expenditures associated with new equipment or systems that can be necessary to operate within a new database model, etc. Moreover, as database models continue to evolve, these constraints can be experienced repeatedly with each exposure to another database model. Additionally, even where a database environment is relatively modern, it can be incompatible with other relatively modern database silos. The plurality of database silos in itself can be an impediment to sharing data among them.

Providing cross model datum access with semantic preservation as disclosed herein, for example, by employing an open universal database gateway (OUDG), can preserve both data and associated data semantics, e.g., cardinality, is-a relationships, generalization, aggregation, etc., to facilitate sharing of data from one database silo with another database silo, e.g., between two data base models. An interim database, comprising a translated datum and preserving related semantic information, can be generated from a first database employing a first database model. Translation to an interim database environment can be termed ‘down translation’. This interim database can facilitate further translation with semantic preservation into another database employing another database model. This translation from the interim database environment can be termed ‘up translation’. In an embodiment, the interim database and database model can act as a sharable database environment, e.g., similar to a middleman or straw man, allowing translation between two or more disparate database models or silos. The interim database can be stored locally or remotely, allowing access for up translation to a destination database environment. As an example, an OUDG device can facilitate down translation of an initial database into a flattened XML model and XML scheme, e.g., an interim database environment, which preserves semantics from the initial database. This interim database environment can then facilitate up translation into another database under a different database model while continuing to preserve data semantics.

Continuing the example, the OUDG device can facilitate both down translation and up translation within the device, allowing cross model datum access with semantic preservation between two disparate database models with a single device. This can facilitate cross model datum access with semantic preservation proximate to a first database silo with communication of the up translated information being sent to a remotely located database silo. This can further facilitate cross model datum access with semantic preservation by communication of the local database to a remote location where an OUDG device can then process the down translation and up translation to make the information accessible at the remote database silo. In another embodiment of the instant example, a first OUDG device can communicate with a second OUDG device to facilitate down translation at the first OUDG device, communication of the interim database, and up translation at the second OUDG device. This can further facilitate storage of the interim database at a location remote from both the first OUDG and the second OUDG, e.g., storing the interim database on a third-party server to facilitate cross model datum access with semantic preservation between a first party database environment and a second party database environment.

As a result, users can access each other's databases via an interim database environment that preserves semantic information from the source database environment. This can let users apply their own familiar query language to access databases employing other database models, for example, SQL can be employed to access an object-oriented database, a network database, or a XML database. Similarly, use OQL, IDMS, or XQuery can be employed to access data in other database silos. Furthermore, an interim database environment can act as a replicate of a source database environment with preservation of the first database and related semantics, to allow the continued use of the source database in parallel with other use of the destination database environment, e.g., where a source database environment is retained, access to the source database can continue with access allowed to replicated content, via the interim database environment, in another database environment by up translating into the other database model from the interim database. Moreover, changes can be pushed back to the source database environment via the interim database environment by down translating changes at the destination database into the interim database then up translating into the source database from the interim database.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter can be practiced without these specific details. In other instances, well-known structures and devices are illustrated in block diagram form in order to facilitate describing the various embodiments of the subject disclosure.

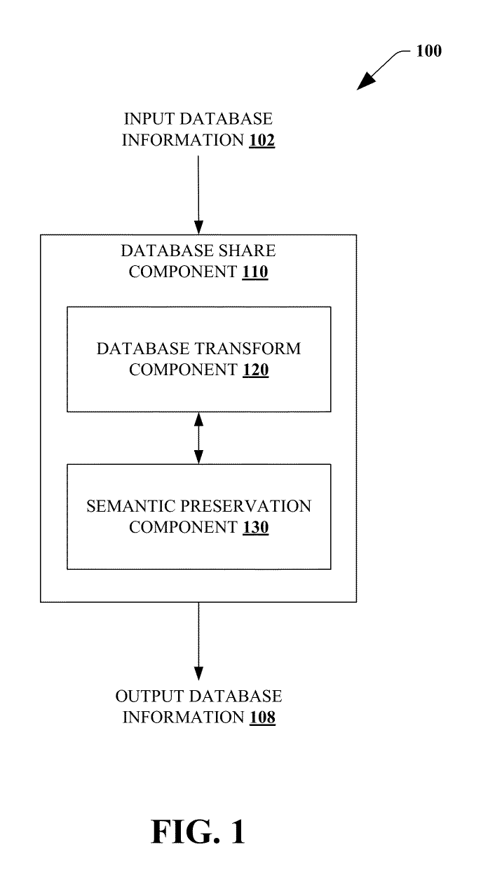

Turning to the figures, FIG. 1 illustrates a system 100 that can facilitate cross model datum access with semantic preservation in accordance with an aspect of the subject matter disclosed herein. System 100 can comprise database share component 110, that can receive input database information 102 and generate output database information 108. Database share component 110 can facilitate cross model datum access with semantic preservation, e.g., can receive input database information 102 in a first database silo, down translate to an interim database preserving semantic information related to the first database silo, up translate to a second database silo again preserving semantic information, and make the up translated information available as output database information 108. In an aspect, the database model of the first database silo, related to input database 102, can be different from the interim database model. Further, the interim database model can be different from the database model associated with the output database information 108. Database share component 110 can comprise database transform component 120 and semantic preservation component 130.

Database transform component 120 can enable down translation and up translation. In an embodiment, database transform component 120 can comprise database model modules or components, not illustrated, that can relate to down translation or up translation of a first datum to a second datum. As an example, input database information 102 can comprise a datum from a database employing a relational database model. Database transform component 120 can down translate the relational database datum into a flat XML datum where the interim database employs a flat XML model. The flat XML datum can then be up translated to a hierarchical database model datum that can be made accessible as part of output database information 108.

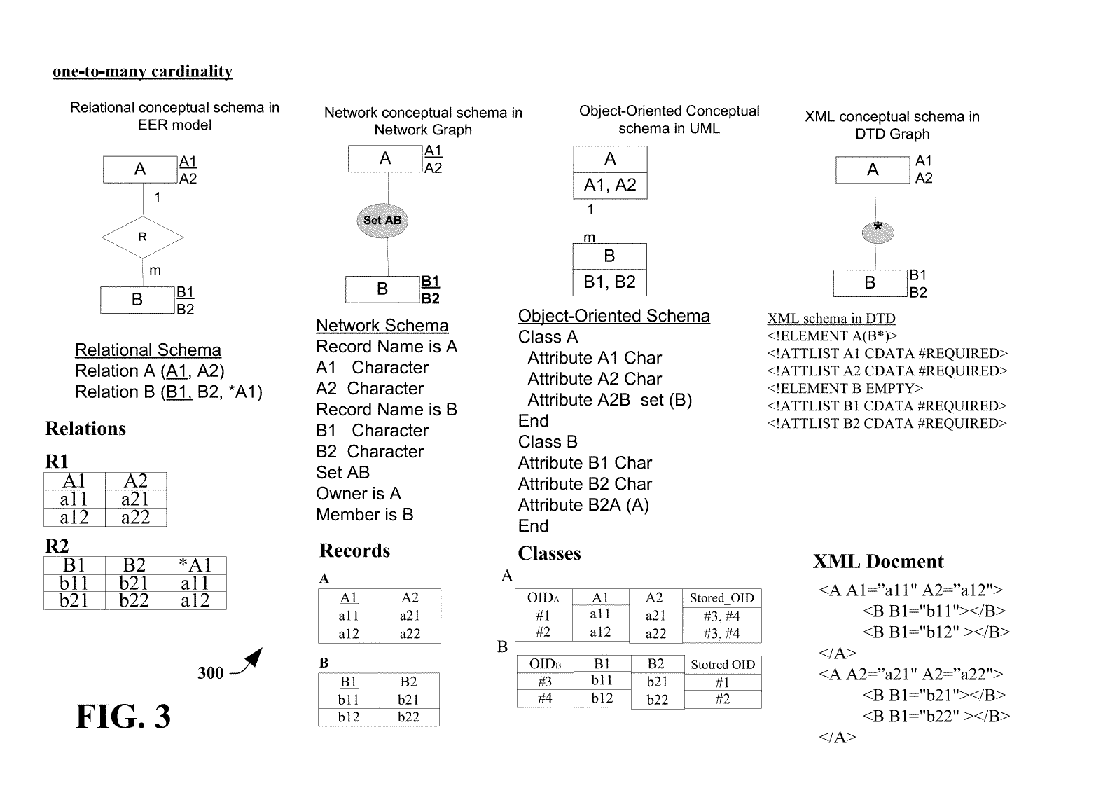

Semantic preservation component 130 can enable preservation of semantic information during down translation or up translation. In an embodiment, input database information 102 can further comprise semantic information related to a datum to be transformed by database share component 110, e.g., via database transform component 120. This semantic information can be translated by semantic preservation component 130 such that semantic information associated with a datum can be preserved between the input database information 102 and the output database information 108. As an example, a one-to-many cardinality for a datum can be preserved in a down translation from a relational database model to a flat XML model and again preserved in an up translation from the flat XML model to an object oriented database model for a datum undergoing translation, e.g., as depicted in part in FIG. 3, etc.

Hereinafter, the interim database environment, e.g., interim database and interim database model or scheme, will generally, for clarity and conciseness, be described as a flat XML database environment, e.g., a flat XML database or document and a flat XML model or scheme, although it is explicitly not so limited. Other embodiments can employ other interim database environments without departing from the scope of the present disclosure, as will be appreciated by one of skill in the relevant art. With regard to flattened XML documents, such as employed in a flattened XML database environment, these can comprise a generic representation of a source database instance in accord with the relevant database model. A source database can be transformed, e.g., by down translating source data comprised in input database information 102, into a flattened XML document(s), that can be further transformed, e.g., up translated, into other database associated with other database models, such as, Relational data models, Object-Oriented data models, Network data models, XML data models, etc. A flattened XML document instance can be a valid XML document which can contains a collection of elements of various types and each element can define its own set of properties. In an embodiment, the structure of the flattened XML document data file can be a flattened relational table structured XML document. This can have XML document syntax and can have an internal relational table structure. Further, it can replace primary key with ID, and can replace foreign key with IDREF as follows:

```
<?xml version=″1.0″>
<root>
  <table1 ID=″...″ IDREF1=″...″ IDREF2=″...″ ... IDREFN=″...″>
    <attribute1>...</attribute1>
      ...
    <attributeN>...</attributeN>
  </table1>
  ...
  <tableN ID=″...″ IDREF1=″...″ IDREF2=″...″ ... IDREFN=″...″>
    <attribute1>...</attribute1>
    <attributeN>...</attributeN>
  </tableN>
</root>
```

In an aspect, for each table, the name of the table (tableN) can determine its type name and the name of a property (attributeN) can determine its property name. Further, each table can define an ID type attribute that can uniquely identify itself and can include optional multiple IDREF type attributes that can refer to the ID in other tables in the same flattened XML document instance. Each property XML element can enclose a property value in a proper textual representation format. In other embodiments, in order to ensure a flattened XML document instance to be valid, there can be either an internal or an external DTD document that can define the XML structures and attribute types, in particular for those ID and IDREF type attributes. A flattened XML document can be transformed, e.g., up translated, into other database models, e.g., relational, object-oriented, XML, network, etc. As such, a destination database model can be selected to receive the result of the up translation of an interim database, e.g., the flattened XML document, with data semantics preservation.

A flattened XML document model can be an easy interim database environment to employ due to its openness and DBMS independence. While other data models can be DBMS dependent, these can also be employed in interim database environments where needed or desirable. As an example, while an Oracle database can typically only be accessed by Oracle DBMS, and a MS SQL Server database can typically only be accessed by MS SQL Server DBMS, where these DBMS technologies are available, they can be employed as an interim database model. However, as previously asserted, flattened XML documents can be accessed more broadly and generally with lower programming requirements. Similarly, a relational table structure can be selected for the flattened XML document because of the strong mathematical foundation for relational algebra as internal data found in relational tables, which can simplify implementing the constraints of major data semantics such as cardinality, is-a, generalization, aggregation, etc. Therefore, flattened XML documents employing relational tables provides for a low barrier to implementation as an interim database environment facilitating interoperability of a plurality of databases, e.g., via database share component 110.

As disclosed herein, database share component 110 can act as database middleware to facilitate access to data in a plurality of database models, e.g., via flattened XML documents. As such, database share component 110 can provide more flexibility in accessing data under other database models than other techniques by allowing the data from the other database model to be translated into a designated destination database model. This can allow, for example, a user that is unfamiliar with a hierarchical database model to translate hierarchical data into a relational database model that they may be familiar with, via database share component 110, such that they can operate on the data after the transformation. The manipulated data can then, where desirable, be pushed back to the hierarchical database model via database share component 110. Further, where XML can be well suited for is use in internet traffic, relaying an interim database in flattened XML format can be easily accomplished and can facilitate rapid access via well understood internet programming techniques.

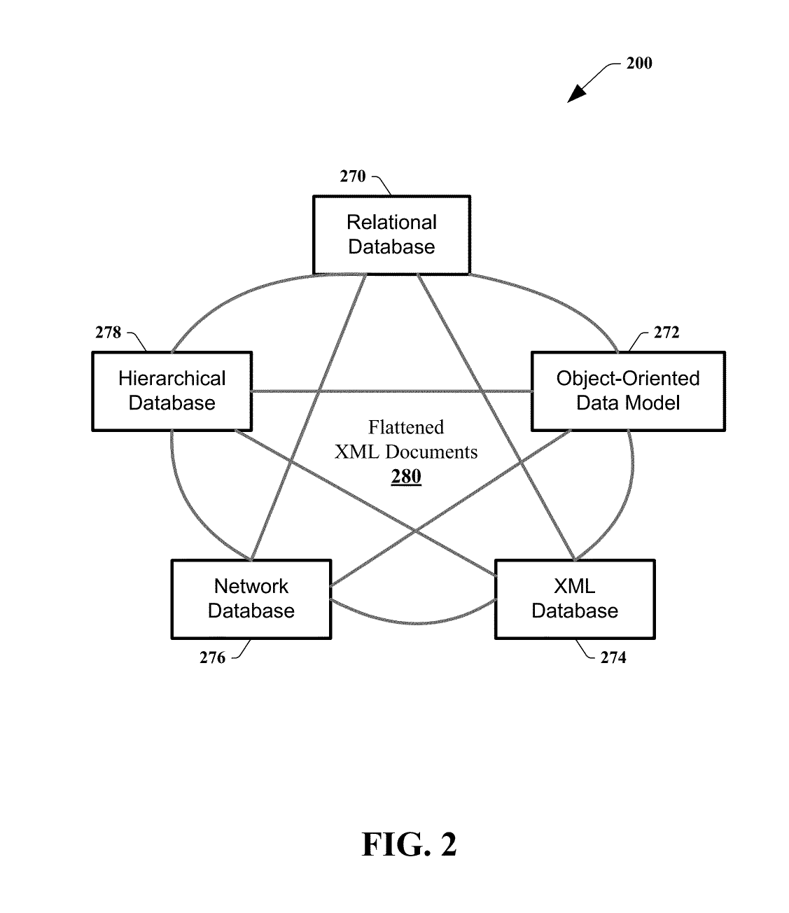

For simplicity and clarity, only four database models are illustrated herein at any substantial length, although any database model can be employed without departing from the scope of the present disclosure. The four example database models include, a network database model for a network database in a network structure, a relational database model for a relational database in a table structure, an XML database model for an XML database in a tree structure, and an object-oriented database model for an object-oriented database in a class structure: However, other database models can be employed, for example, a hierarchical database model, such as illustrated in FIG. 2 at 278.

For ease of understanding, translation undertaken by database share component 110 can be described in pseudo code, as follows:

```
Begin;
  If source database conceptual schema for source datum
comprised in input database information 102 does not exist,
  Then determine source database schema and
translate into a conceptual schema;
  Transform source datum into interim datum for interim database
model, e.g., for flattened XML document;
  Transform interim datum, e.g., from flattened XML document,
into destination database and make available as part of
output database information 108;
End;
```

In an embodiment, input database information 102, comprising an input datum and source database model information, can be received by database share component 110 and placed into a sequential file based on the source database model information or scheme, e.g., down translation. The sequential file can then be uploaded, e.g., made available as part of output database information 108, into a destination database based on the destination database model or schema. This logical level approach can avoid physical data type conversion. Therefore, the transformation from source to destination database can employ a flattened XML document as part of an interim database model to reduce the number of programs employed in the conversion of the datum. Where the interim database model is not employ, for example, for translation between four database models can require 4*4=16 programs, e.g., A-to-B, A-to-C, A-to-D, A-to-A, B-to-A, B-to-C, B-to-D, B-to-B, C-to-A, C-to-B, C-to-D, C-to-C, D-to-D, D-to-A, D-to-B, and D-to-C, for database models A, B, C, and D. Where more than four database models are in use, this number can grow rapidly. In contrast, the use of the interim database model that can instead employ only 4+4=8 programs for data conversion, e.g., A-to-Interim, B-to-Interim, C-to-Interim, D-to-Interim, Interim-to-A, Interim-to-B, Interim-to-C, and Interim-to-D.

With regard to preservation of semantic information, data semantics can include primitive and advance data semantics. Primitive data semantics can include cardinality, is-a relationships, generalization and aggregation. Advanced data semantics can include, N-ary relationship, participation, weak entity, categorization, etc., can be derived from the primitive data semantics. Table 1 provides information related to data semantic preservation in the four example database models and a flattened XML database model.

Cardinality, in an aspect, can be 1:n and can be constructed by a foreign key on “many” sides referring to a primary key on “one” side in a relational database model or scheme. In a further aspect, an association attribute of a class object on “one” side can point to another class objects on “many” sides in an object-oriented schema. In another aspect, an owner record occurrence on “one” side can be associated with member record occurrences on “many” sides in a network schema. In a further aspect, an element occurrence with IDREF on “many” sides can link with an element occurrence with ID on “one” side in an XML schema. With regard to m:n cardinality, this can be implemented by employing two 1:n cardinalities with two “one” side classes that can link with the same “many” sides class.

An is-a relationship, in an aspect, can be a subclass relation that has the same primary key as its superclass relation, and can refer to a superclass primary key as a foreign key in a relational schema. In another aspect a subclass can inherit its superclass's OID and attributes in an object-oriented schema. In a further aspect, an owner record can have the same key as its member record via SET linkage in a network schema. In another aspect, an element can link a one-to-one occurrence with its sub-element in an XML schema.

Table 1 showing information related to data semantic preservation.

| | Data model | | | | |
|---|---|---|---|---|---|
| Data Semantic | Relational | Object-Oriented | Network | XML | Flattened XML |
| 1:n cardinality | Many child | A class's | An owner record | An element has | The IDREF(s) |
| | relations' foreign | association | data points to | many sub- | of a “many” |
| | keys referring to | attribute refers to | many member | elements. | side sibling |
| | same parent | another class's | records data via | | element's data |
| | relation's primary | many objects' | SET linkage. | | refer to an ID of |
| | key. | OID(s) as a | | | “one” side |
| | | Stored OID. | | | sibling element |
| | | | | | data. |
| m:n | A relationship | A class's | Two owner | A sub-element | An sibling |
| cardinality | relation's | association | records data | links 1 element | element data |
| | composite key | attribute refers to | point to the same | in element sub- | has 2 IDREF(s) |
| | are foreign keys | another class's | member record | element linkage | referring to 2 |
| | referring to 2 | many objects' | data via 2 SETs | and another | other sibling |
| | other relations' | OID(s) as an | linkages. | element in sub- | elements ID(s) |
| | primary keys. | Stored OID, and | | element IDREF | data. |
| | | vice versa. | | referring to | |
| | | | | element ID | |
| | | | | linkage | |
| ls-a | Subclass relation's | A subclass | An owner record | An element | The IDREF of a |
| | primary key is a | inherit OID(s), | data links to a | occurrence | subclass sibling |
| | foreign key | attributes and | member record | links with a | element data |
| | referring to its | methods of its | data in 1:1 with | sub-element | refers to the ID |
| | superclass | superclass as its | same key. | occurrence in | of a superclass |
| | relation's primary | OID plus its own | | 1:1 linkage. | sibling element. |
| | key. | additional | | | Both elements |
| | | attributes and | | | has common |
| | | methods. | | | key value. |
| Generalization | 2 subclass | Two subclasses | An owner record | An element | The IDREF(s) |
| | relations' primary | inherit OID and | data occurrence | data occurrence | of 2 subclass |
| | keys are foreign | attributes of their | points to two | links with two | sibling |
| | keys referring to | identical | member records | sub-elements | elements data |
| | same superclass | superclass as | data occurrence | data occurrence | occurrence |
| | relation's primary | their OID plus | with same key. | in 1:1 linkages. | refer to an ID of |
| | keys. | their own | | | a superclass |
| | | additional | | | sibling element |
| | | attributes. | | | data occurrence |
| | | | | | They all have |
| | | | | | same key value. |
| aggregation | An aggregation | An aggregation | An aggregation | A group | A group |
| | relation links with | class owns | record points | element has | element has |
| | its component | components | components | component | component |
| | relations. Delete | classes such that | records such that | elements such | elements such |
| | aggregation | delete | delete | that delete | that delete |
| | relation will | aggregation | aggregation | group element | group element |
| | delete its | class will delete | record will | will delete | will delete |
| | components | component | delete | component | component |
| | relations. | classes. | component | elements. | elements. |
| | | | records. | | |

A generalization relationship, in an aspect, can be where both a superclass relation and a subclass relation have the same key, with the subclass relations' keys referring to the superclass key as foreign key, in a relational schema. In another aspect, in an object-oriented scheme, multiple subclass objects can have the same OID as their common superclass object. The subclasses' objects can inherit their common superclass's object attributes and methods. In a further aspect, for a network scheme, one owner (superclass) record can link with multiple member (subclasses) records through a SET. In a still further aspect, multiple subclass elements and their superclass element can be in 1:1 linkage with the same key attribute in an XML scheme.

An aggregation relationship, in an aspect, can be deleted if its component relations are also deleted in a relational scheme. Similarly, in another aspect, an aggregation class can own component classes, such that the deletion of the aggregation class implies the deletion of the component classes, in an object-oriented scheme. In a further aspect, an aggregation record can link with component records, such that the deletion of the aggregation implies the deletion of the component record, in a network scheme. In a still further aspect, an aggregation element can associate with component elements such that the deletion of the group element implies the deletion of the component elements in an XML scheme.

In an embodiment, where input database information 102 does not include identification of a source database model or scheme, such as where one does not yet exist or it has become obsolete, it can be necessary to recover source data semantics by determining the source database logical model or scheme and defining a source database conceptual model of scheme based on the determined logical model. For example, to recover an enhanced entity-relationship (EER) model from a relational schema, a classification table can be used to define the relationship between keys and attributes in the relations, and data semantics can be recovered accordingly. A 1:n cardinality in a relational schema can be recovered from a foreign key (FKA) between two relations in a classification table, with foreign key relation on the “many” side and referred primary key relation on the “one” side, etc. Similarly, recovery of a 1:n association between two associated objects with a Stored OID in a class referring to many OID(s) in another associated class in OODB can be accomplished. Further, a 1:n cardinality from owner and members records of Network schema into Network database conceptual schema can be recovered, and also element and sub-elements in a XML schema can be recovered into an XML conceptual schema.

In an aspect, metadata can be captured based on source and/or destination database models. Metadata can be summarized in Table 2.

Table 2 showing metadata that can be captured based on a source database model or a destination database model.

| | | | | | | | | | | | |
|---|---|---|---|---|---|---|---|---|---|---|---|
| Table name | PR1 | PR2 | SR1 | SR2 | KAP | KAG | FKA | NKA | cardinality | Is-a | Aggregation |

Object-Oriented database meta data

| | | | | | | |
|---|---|---|---|---|---|---|
| Class name | Attributes | OID | Stored OID(s) | Cardinality | Is-a | Aggregation |

XML database meta data

| | | | | | | |
|---|---|---|---|---|---|---|
| Element name | Attribute(s) | ID | IDREF(s) | cardinality | Is-a | Aggregation |

Network database meta data

| | | | | | | | |
|---|---|---|---|---|---|---|---|
| Record Name | Attribute(s) | Key | Owner | Member | Cardinality | Is-a | Aggregation |

### Where:

Data Type=primitive data format of each attribute in the data model
Table name=relation name.
PR1=This is a relation whose primary key does not contain a key of another relation.
PR2=This is a relation whose primary key does contain a key of another relation.
SR1=This is a relation whose primary key is fully formed by concatenation of primary keys of other relations.
SR2=This is a relation whose primary key is partially formed by concatenation of primary keys of other relations.
KAP=This is an attribute in the primary key of SR1 that is also a key of some primary relations PR1 or SR1.
KAG=These are all the other primary key attributes in a secondary relation SR1 or SR2 that are not of the KAP type.
FKA=This is a foreign key attribute of a relation.
NKA=This is a non-key attribute.
OID=object identity in object-oriented schema
Stored OID=The OID value of association attribute in object-oriented schema.
ID=unique address of an element data occurrence in XML schema.
IDREF=pointer structure of an element referring to another element data occurrence.
Owner=the owner record linked by a SET to a member record in network schema.
Member=the member record linked by a SET to a member record in network schema.
Key=the key attribute of a record in network schema.

Transformation of a source database, e.g., datum included in input database information 102, can include preprocessing to map the source database model into an interim database model, e.g., a flattened XML database model. Further, corresponding datum conversion can be effected.

In an embodiment, where the source database model is a relational database model, a system can, for example, read a relational table based on the source database model, e.g., a relational schema. As such, in a one-to-many data semantic, parent and child relations can be posted into table structured sibling XML elements linked with id and idref. Further, in a many-to-many data semantic, two relations and their relationship information can be posted into table structured XML sibling elements linked with idref(s) and id(s). Similarly, in an is-a data semantic, superclass and subclass relations can be posted into table structured XML sibling elements linked with id and idref with the same key. Further, in a generalization data semantic, superclass relation and subclasses relations can be posted into XML sibling elements linked with id(s) and idref(s) with the same key in flattened XML schema DTD “,” separator. Pseudo code for mapping a relational database model into a flattened XML database model can, for example, be similar to the following:

```
BEGIN
  Select an artifact root element for flattened XML schema;
  Map all parent only (PR1 in classification table)
entities into sibling elements under root element;
    If relation B foreign key refers to relation A primary key
    Then begin
    Map relations A and B of 1:n cardinality into sibling
elements A and B of 1:n cardinality;
    /*A is one and B is many */
      map relation A into sibling element A with ID;
      map relation B into sibling element B with IDREF
refer to the above ID;
      end;
  If relation B has a primary key which is also a foreign
key refers to relation A primary key
    Then begin
    Map relation A is-a relation B into sibling
element A is-a sibling element B;
    /*A is subclass and B is superclass */
    map relation A into sibling element A with ID
value of relation key value;
      map relation B into sibling element B with
IDREF value of the same relation key value;
      end;
  If (relation A and relation B is in 1:n cardinality)
And (relation C and relation B is in 1:n)
  Then relation A and relation C are in m:n cardinality;
  If (relation A is-a relation B) and (relation C is-a relation B)
  Then relation A and relation C are generalized into relation B;
    /* A and C are subclass, and B is their superclass */
  If a composite key of a relationship relation BC
refer primary keys of relations B and C
  Then begin
    Map aggregation of relations BC,B,C into
aggregation of sibling elements BC,B,C;
    /* aggregation components B,C,BC*/
    map relation B into sibling element B with ID value;
    map relation C into sibling element C with ID value;
    map relation BC into sibling element BC with
IDREF(s) refer to the above ID(s);
    end;
END;
```

Pseudo code for transforming a source datum or database from a relational database model into a flattened XML document, e.g., down translating, can, for example, be similar to the following:

```
BEGIN
  Create a raw XML document with an arbitrary root element r
  For each table do
  begin
    For each record rec do
  begin
  Create an XML element e named as its table name
  If table of the record defines a primary key pk
  then begin
    Create an ID attribute id named table-name.column-name
with value table-name.primary-key-value;
    Add the above id as attribute of e;
    end;
    For each foreign key fk of the table do
    begin
    Create an IDREF attribute idref named primary-table-
name.foreign-key-column-name with value
    primary-table-name.foreign-key-value;
    Add the above idref as attribute of e;
    end
  end
Add e as child element of r;
END
```

In another embodiment, where the source database model is an XML database model, a system can, for example, read an XML document according to the XML schema. In a one-to-many data semantic, an element and sub-element can be posted into XML sibling elements linked with id and idref. In a many-to-many data semantic, three elements linked with id(s) and idref(s) can be posted into XML sibling elements linked with id(s) and idref(s). Similarly, in an is-a data semantic, superclass and subclass elements can be posted into XML sibling elements linked with id and idref with the same key. Further, in a generalization data semantic, element and sub-elements can be posted into XML sibling elements linked with id(s) and idref(s) with the same key in DTD “,” separator in the flattened XML document schema. Pseudo code for mapping an XML database model into a flattened XML database model can, for example, be similar to the following:

```
BEGIN
  If element A and its sub-element B have same
attribute a1 in XML schema
  Then begin
    Map element A is-a element B into sibling elements
A is-a B; /*A is subclass and B is superclass */
    map element A with key a1 into sibling element A
with key a1 and an ID value into flattened XML schema;
    map element B with key a1 into sibling element B
with key a1 and IDREF with above ID value into XML schema;
    end;
  If (sub-element B under element A) or (element B has an
IDREF referring to element A ID value)
  Then begin
    Map sibling elements A and B in 1:n cardinality into
elements A and B in 1:n cardinality;
    /*A is subclass & B is superclass */
    Map element A into sibling element A with an ID
value in flattened XML schema;
    Map element B into sibling element B with an IDREF
referring to the above ID value in flattened XML schema;
    End;
  If (element A and element B is in 1:n cardinality) And
(element C and element B is in 1:n)
  Then element A and element C are in m:n cardinality in XML schema;
  If (element A is-a element B) and (element C is-a element B)
  Then element A and element C are generalized into
element B; /* A,C are subclasses to superclass B */
  If a group element BC has component elements B and C
  Then begin
    Map aggregation with elements BC,B,C into
aggregation with sibling elements BC,B,C;
    /*aggregation components BC,B,C*/
    map element B into sibling element B with ID value;
    map element C into sibling element C with ID value;
    map element BC into sibling element BC with IDREF(s)
refer to the above ID(s);
  end;
END;
```

Pseudo code for transforming a source datum or database from an XML database model into a flattened XML document, e.g., down translating, can, for example, be similar to the following:

```
Begin
  Perform depth first search on the input XML document instance;
    For each XML element do
    begin
      Add an ID attribute id with value ″entity:sequence_number″;
      Add an IDREF attribute idref with value
″parent_element_name:seqeuence number of parent;
      Create a new blank XML document with root as root element;
      Perform depth first search (top-to-bottom, left-to-right
and front-to-back) on the input XML document instance;
      For each element in the input XML document instance do
      Add a sibling XML element with attributes id and idref to
the new XML document;
end;
```

In a further embodiment, where the source database model is an object-oriented database model, a system can, for example, read OODB according to the OODB schema. For a one-to-many data semantic, an object and a set of associated objects can be posted into XML sibling elements linked with id and idref. In a many-to-many data semantic, two sets of associated objects with a common object can be posted into three XML sibling elements such that a sibling element with two IDREF(s) referring two sibling elements with two ID(s)). For an is-a data semantic, superclass and subclass objects with the same OID can be posted into XML sibling elements linked with id and idref with the same key. In a generalization data semantic, superclass and multiple subclass objects can be posted into table structured XML sibling elements linked with id(s) and idref(s) with the same key in DTD “,” separator in the flattened XML document schema. Pseudo code for mapping an object-oriented database model into a flattened XML database model can, for example, be similar to the following:

```
Begin
  If B is subclass of class A
  Then begin
        Map class B is-a class A into sibling element
A is-a sibling element B;
        /* B is subclass and A is superclass */
        map class A with OID into sibling element A with
ID value same as OID;
        map class B with same OID as above into sibling
element B with IDREF referring to the above ID value;
      end;
    If class A has association attribute (A2B) referring
to class B's multiple objects
    Then begin
      Map Classes A and B in 1:n cardinality into
sibling elements B and C in 1:n cardinality;
        /* A is one and B is many */
      Map class A with OID into sibling element A with
ID value same as OID;
      Map class B with stored OID into sibling element
B with IDREF referring to the above ID value;
    End;
  If (sibling element A and sibling element B are in 1:n cardinality)
And (sibling element C and sibling element B is in 1:n)
  Then sibling element A and sibling element C are in m:n cardinality;
  If (sibling element A is-a sibling element B) and
(sibling element C is-a sibling element B)
  Then sibling element A and sibling element C are generalized
into sibling element B; /*A,C are subclass to superclass B*/
  If a class BC owns classes B and C
  Then begin
      Map aggregation with classes BC,B,C into aggregation
with sibling elements BC,B,C;
      /*aggregation components BC,B,C*/
      map class B into sibling element B with ID value;
      map class C into sibling element C with ID value;
      map class BC into sibling element BC with IDREF(s)
refer to the above ID(s);
      end;
End;
```

Pseudo code for transforming a source datum or database from an object-oriented database model into a flattened XML document, e.g., down translating, can, for example, be similar to the following:

```
Begin
  Create a flattened XML document with a root element
  For each class c in OODB do
  Begin
    For each object obj in class c do
    Begin
    Derive an OID for class c for object obj;
        Create a sibling XML element for object obj as child element of
root element of flattened XML document with OID
        as ID type attribute;
    End
  For each association attribute of obj do
    Begin
          For each stored referred obj do
      Begin
            Locate the corresponding sibling XML element e in flattened
XML document:
            Create an IDREF attribute for element e:
      End
    End
  End
End
```

In another embodiment, where the source database model is a network database (NBD) model, a system can, for example, read NDB according to the NDB schema. In a one-to-many data semantic, owner and member records can be posted into XML sibling elements linked with id and idref. In a many-to-many data semantic, two owners and one common member record can be posted into XML sibling elements linked with id(s) and idref(s). For an is-a data semantic, an owner and a member record can be posted into XML sibling elements linked with id and idref with the same key. In a generalization data semantic, owner and member records can be posted into table structured XML sibling elements linked with id(s) and idref(s), with the same key in the flattened XML document schema DTD “,” separator. Pseudo code for mapping an network database model into a flattened XML database model can, for example, be similar to the following:

```
Begin
  If (owner record A has a key value attribute a1) and (member record B
under owner record A has same key value a1)
  Then begin
        Map Record B is-a record A into sibling element A is-a sibling
element B; /* A is subclass and B is superclass */
        Map record A into sibling element A with an attribute a1 and with
ID value into flattened XML schema;
        Map record B into sibling element B with as above and an IDREF
referring to above ID value into flattened XML
              schema;
      End;
    If member record B under owner record A
    Then begin
          Map Records A and B in 1:n cardinality into sibling elements
A and B in 1:n cardinality;
                /* A is one and B is many */
          Map record A into sibling element A with ID value into flattened
XML schema;
          Map record B into sibling element B with IDREF referring to
the above ID value into flattened XML schema;
            End;
      If (sibling element A and sibling element B is in 1:n cardinality) And
(sibling element C and sibling element B is in 1:n)
      Then sibling element A and sibling element C are in m:n cardinality;
      If (sibling element A is-a sibling element B) and (sibling element C
is-a sibling element B)
      Then sibling element A and sibling element C are generalized into
sibling element B;
      /* A,C are subclass to superclass B*/
      If an owner record BC has member records B and C
      Then begin
              Map aggregation with sibling elements BC,B,C into
aggregation with elements BC,B,C;
                /*aggregation components BC,B,C*/
                map record B into sibling element B with ID value;
                map record C into sibling element C with ID value;
                map record BC into sibling element BC with IDREF(s)
refer to the above ID(s);
              end;
      End;
```

Pseudo code for transforming a source datum or database from an network database model into a flattened XML document, e.g., down translating, can, for example, be similar to the following:

```
Begin
  Create a flattened XML document with a root element
  For each record type t in NDB do
  begin
      For each record r of type t do
      Begin
        Locate the key for type t for record r;
          Create a sibling XML element for record r as child element of
root element of flattened XML document with key as
          ID type attribute;
      End
  end
  For each set s in NDB do
  Begin
    For each i in s do
    Begin
        For the non-owner record type t defined by s do
        Begin
            Locate the corresponding sibling XML element e in
flattened XML documents;
            Create an IDREF attribute for sibling element e for the
owner record defined by I;
        End
    End
End
```

At this point, the database model and data in the database is transformed from the source database environment to the interim database environment, e.g., down translation. This includes preservation of semantic information related to the transformed data. At this point, up translation can be undertaken to transform the interim database model and data to a destination database model and data. This again preserves semantic information. Further, as with the down translation, the up translation can be discussed for each of the four example database models, e.g., relational, object-oriented, network, and XML. Transformation of an interim database, e.g., the flattened XML document and related database model or scheme, can include preprocessing to map the interim database model into a destination database model. Further, corresponding datum conversion can be effected.

In an embodiment, where the destination database model is a relational database model, a system can, for example, read the flattened XML document according to flattened XML model or schema. In a one-to-many data semantic, XML sibling elements can be posted into parent and child relations. In a many-to-many data semantic, XML sibling elements linked with id(s) and idref(s) can be posted into two parents and one child relation. For an is-a data semantic, XML sibling elements can be posted into superclass relation and sub-class relation. In a generalization data semantic, XML sibling elements can be posted into a superclass relation and two subclass relations. Pseudo code for mapping a flattened XML database model to a relational database model can, for example, be similar to the following:

```
Begin
  If (sibling element A with ID value of relation key value) and (sibling
element B with IDREF value of the same relation
    key value)
  Then begin
        Map Sibling element B is-a sibling element A into relation A
        is-a relation B;
/* B is a subclass to A */
        Map sibling element A into relation A with primary key = ID
        value;
        Map sibling element B into relation B with primary key = foreign
key with same value;
      End;
  If (sibling element A with ID value) and (sibling element B with IDREF
value of the same value)
  Then begin
        Map Sibling elements A and B in 1:n cardinality into relations
A and B in 1:n cardinality;
          /* A is one and B is many*/
        Map sibling element A into relation A with primary key = ID
        value;
        Map sibling element B into relation B with foreign key referring
to primary key ID value;
      End;
  If (sibling element A and sibling element B is in 1:n cardinality)
  And (sibling element C and sibling element B is in 1:n)
  Then sibling element A and sibling element C are in m:n cardinality;
  If (sibling element A is-a sibling element B) and (sibling element C
is-a sibling element B)
  Then sibling A and sibling element C are generalized into sibling
  element B;
        /* A,C are subclass, and B is their superclass */
  If an aggregation exists with component sibling elements BC, B and C
  Then begin
        Map aggregation with sibling elements BC, B and C into
aggregation with relations BC, B and C;
          map sibling element B with ID into relation B with ID as
primary key value;
          map sibling element C with ID into relation C with ID as
primary key value;
          map sibling element BC with 2 IDREF(s) into sibling element
BC with IDREF(s) as composite key refer to the
          above ID(s);
      end;
End;
```

Pseudo code for transforming a source datum or database from a flattened XML document into a relational database model into, e.g., up translating, can, for example, be similar to the following:

```
Begin
      Let s be an empty statement sequence;
      For each sibling XML element with entity prefix e do
        begin
            Derive table name t from sibling element name of e without
            entity prefix;
            For each sub element c of e do /* extract attributes from the
sub-elements in flattened XML document */
            Begin
              Derive col from name of c without property prefix;
              Derive val from child text node contents of c;
            If c is the first sub element
            Then begin
                      Let cols = “col”;
                  Let vals = “‘val’”;
                End;
            Else begin
                    Append “,col” to cols;
                    Append “,‘val’” to vals;
              End;
End
    Let i = “INSERT INTO t (cols) VALUES (vals)”;
          Add i to s;
        End
  Return s
End
```

In an embodiment, where the destination database model is an object-oriented database model, a system can, for example, read the flattened XML document according to flattened XML model or schema. In a one-to-many data semantic, XML sibling elements can be posted into a pair of associated objects with OID and Stored OID. In a many-to-many data semantic, XML sibling elements linked with id(s) and idref(s) can be posted into a pair of associated objects. For an is-a data semantic, XML sibling elements can be posted into superclass and its sub-class object. In a generalization data semantic, flattened structured XML sibling elements with the same key can be posted into objects and their subclass objects with the same OID. Pseudo code for mapping a flattened XML database model to a relational database model can, for example, be similar to the following:

```
Begin
  If  (sibling element A with an attribute a1 and an ID value)
      And (sibling element B with same attribute a1 and an IDREF value same as the
above ID value)
  Then begin
            Map sibling element B is-a sibling element A into class B is-a class
A;/*subclass B refer to superclass A*/
        map sibling element A into class A with attribute a1 into object-oriented
schema;
        map sibling element B into subclass B of class A in object-oriented schema;
            end;
  If  (sibling element A with an ID value)
      And (sibling element B with an IDREF value referring to the above ID value)
  Then begin
        Map sibling elements A and B in 1:n cardinality into classes A and B in 1:n
cardinality; /*A is one and B is many */
        map sibling element A into class A with association attribute A2B referring to
class B's multiple objects in OODB
            schema;
        map sibling element B into class B with association attribute B2A referring to
class A's object in OODB schema;
        end;
    If (sibling element A and sibling element B is in 1:n cardinality)
    And  (sibling element C and sibling element B is in 1:n)
    Then sibling element A and sibling element C are in m:n cardinality;
    If (sibling element A is-a sibling element B) and (sibling element C is-a sibling
element B)
    Then sibling A and sibling element C are generalized into sibling element B;
/*A,C are subclass & B is their superclass */
    If an aggregation exists with component sibling elements BC, B and C
    Then begin
        Map aggregation with sibling elements BC, B and C into aggregation with
relations BC, B and C;
              map sibling element B with ID into relation B with ID as primary key value;
              map sibling element C with ID into relation C with ID as primary key value;
              map sibling element BC with 2 IDREF(s) into sibling element BC with
IDREF(s) as composite key refer to the
              above ID(s);
          end;
    end;
```

Pseudo code for transforming a source datum or database from a flattened XML document into a relational database model into, e.g., up translating, can, for example, be similar to the following:

```
Begin
  For i = 1 to m do /* for each sibling element Ai with data occurrence
  A1....Am */
  For j = 1 to n do /* for each sibling element Aj data occurrence A1...An
such that i≠j*/
  Begin
        If  (sibling element Ai ID name = sibling element Ai IDREF
        name)
        and (sibling element Aj ID name = sibling element Ai IDREF
        name)
      Then sibling element Ai is-a sibling element Aj; /* subclass element
Ai and superclass element Aj */
      If sibling element Ai ID name = sibling element Aj IDREF name
      Then sibling element Ai and sibling element Aj are in 1:n
cardinality; /* element Ai links many element Aj */
        If sibling element Ai IDREF name = sibling element Aj ID name
      Then sibling element Ai and sibling element Aj are in n:1 cardinality;
/* many element Ai links element Aj */
Case sibling element Ai and sibling element Aj are in
1:n begin
      Output insert statement with Ai data + association attribute value
      “{ }”;
      Output insert statement with Aj data;
    End;
n:1 begin
      Output insert statement with Ai data;
      Output insert statement with Aj data + association attribute null
      value;
    End;
Is-a: begin
        Output insert statement with Ai data + to-be-inherited superclass
attributes value with the same key;
      Output insert statement with Aj data;
    End;
Case end;
End;
  For i = 1 to m do /* for each sibling element Ai with data occurrence
  A1....Am */
  For j = 1 to n do /* for each sibling element Aj data occurrence A1...An
such that i≠j*/
  Begin
  Case sibling element Ai and sibling element Aj are in
  1:n:  Output update statement of Aj to replace “{ }” value with
associated Stored OID(s) in text file T;
  n:1:  Output update statement of Aj to replace null value with
associated Stored OID in text file T;
      case end;
  end;
  Execute OODB DML (data manipulation statements) in the text file T
by OODB DBMS (database management systems);
end
```

In an embodiment, where the destination database model is a network database (NDB) model, a system can, for example, read the flattened XML document according to flattened XML model or schema. In a one-to-many data semantic, XML sibling elements can be posted into a pair of owner and member records. In a many-to-many data semantic, XML sibling elements linked with id(s) and idref(s) can be posted into two owners link with one member record with the same key. In an is-a data semantic, XML sibling elements can be posted into one owner and one member record with the same key. In a generalization data semantic, XML sibling elements linked with id(s) and idref(s) can be posted into one owner and two member records with the same key.

The Raima database can be used as a reference network database implementation. In order to import data to the NDB, Raima provides a utility that can read a sequence data file.

In a Raima, to define an entity type with properties, the following example record definition can be employed:

record investor {
double money_mkt;
char name;
unique key short invID;}

Further, in Raima, to define the linkages among the entities, the following example set definition can be employed:

set inv_trans {
order last;
owner investor;
member asset; }

Once the database definition is properly defined with a DDL file, Raima can provide a utility application and API for creating a database. Pseudo code for mapping a flattened XML database model to a network database model, such as a plain text sequential file, can, for example, be similar to the following:

```
Begin
  If  (sibling element A with an attribute a1 and an ID value)
    And (sibling element B with same attribute a1 and an IDREF value
same as the above ID value)
  Then begin
      Map sibling element B is-a sibling element A into record B is-a
record A; /* B is subclass, and A is superclass */
      map sibling element A with attribute a1 into owner record A with
key attribute a1 into network schema;
      map sibling element B with attribute a1 into member record B under
record A with same attribute a1 into network
        schema ;
        end;
  If  (sibling element A with an ID value)
    And (sibling element B with an IDREF value referring to the above
    ID value)
  Then begin
      Map sibling elements A and B in 1:n cardinality into records A and
B in 1:n cardinality; /*A is one and B is many */
      map sibling element A with attribute ID value a1 into owner record
A with key attribute a1 into network schema;
      map sibling element B into member record B under record A into
network schema;
        end;
  If  (sibling element A and sibling element B is in 1:n cardinality)
  And (sibling element C and sibling element B is in 1:n)
  Then sibling element A and sibling element C are in m:n cardinality;
  If (sibling element A is-a sibling element B) and (sibling element C is-a
sibling element B)
  Then sibling A and sibling element C are generalized into sibling
element B; /*A,C are subclass, & B is their superclass */
  If an aggregation exists with component records BC, B and C
  Then begin
      Map aggregation with sibling elements BC, B and C into aggregation
with records BC, B and C;
          map sibling element B with ID into record B with ID as primary
          key value;
          map sibling element C with ID into record C with ID as primary
          key value;
          map sibling element BC with 2 IDREF(s) into owner record
BC with member records B and C via a SET;
        end;
end;
```

Pseudo code for transforming a source datum or database from a flattened XML document into a network database model into, e.g., up translating, can, for example, be similar to the following:

```
//* Step 1: Create CSV file from flattened XML document */
begin  Read flattened XML document
    For each XML element e do
    Begin
      Derive the internal table name t from element name of e;
      Use t as the CSV file name;
      For each sibling element c of e do;
      Begin
        Derive val from attribute contents of c;
        If c is the first sibling element
        Then begin
          Let vals =‘val’;
        End;
        Else begin
          Let vals =‘val’;
          Append “,” to vals;
        End;
        Add vals to the CSV file;
      Begin
      Export the CSV file;
    End
End
//Step 2: Macro-call program
Macro-call: use a utility provided by NDB DBMS (Raima) to import the data
from a CSV file to the database. As an example, the utility in Raima is
named “dbimp”. “dbimp” is in command format and only executable in
command prompt. Before “dbimp” is used, a text-based import file is written.
An import file defines which database to import data into. Then, for each
record, specify the CSV file to import data from. This can be achieved, for
example, by a “foreach” command followed by the CSV file name. After
this, “{” and “}” can be employed to include a record name and attribute
name. The keyword “field” can be used in front of each attribute. For
example,
Database !network database name
foreach “!data file name.csv”{
  record ! =“record name”
field !field name = 1;
...
Field !field name = n”
}
//Step 3: Upload data and query the NDB instance (in Raima) by computer
automation
Import data to the NDB instance by use of utility “dbimp”.
If the data import successfully, all data will be queried and output
contemporaneously.
End
```

In an embodiment, where the destination database model is an XML database model, a system can, for example, read flattened XML documents according to flattened XML documents schema. In a one-to-many data semantic, XML sibling elements can be posted into a pair of XML element and sub-elements. In a many-to-many data semantic, XML sibling elements linked with id(s) and idref(s) can be posted into XML elements and sub-elements. In an is-a data semantic, XML sibling elements with the same key can be posted into XML element and sub-elements with the same key. In a generalization data semantic, XML sibling elements can be posted into XML element and sub-elements with the same key. Pseudo code for mapping a flattened XML database model to a relational database model can, for example, be similar to the following:

```
Begin
  If  (sibling element A with an attribute a1 and an ID value)
    And (sibling element B with same attribute a1 and an IDREF value
same as the above ID value)
  Then begin
      Map sibling element B is-a sibling element A into element B
      is-a element A;
/* B is subclass and A is superclass */
      map sibling element A into element A with attribute a1 in XML
      schema;
      map sibling element B into element B with attribute a1 and IDREF
value same as above ID value in XML schema;
        end;
  If  (sibling element A with an ID value)
    And (sibling element B with an IDREF value referring to the above
    ID value)
  Then begin
      Map sibling elements A and B in 1:n cardinality into elements A
and B in 1:n cardinality; /*A is one & B is many */
      map sibling element A into element A in XML schema;
      map sibling element B into element B under element A in XML
      schema;
        end;
  If (sibling element A and sibling element B is in 1:n cardinality)
  And  (sibling element C and sibling element B is in 1:n)
  Then sibling element A and sibling element C are in m:n cardinality;
  If (sibling element A is-a sibling element B) and (sibling element C is-
a sibling element B)
  Then sibling A and sibling element C are generalized into sibling element
  B;
/*A,C are subclass & B is their superclass */
  If an aggregation exists with component sibling elements BC, B and C
  Then begin
      Map aggregation with sibling elements BC, B and C into
aggregation with elements BC, B and C;
        map sibling element B with ID into element B with same ID value;
        map sibling element C with ID into element C with same ID value;
        map sibling element BC with 2 IDREF(s) into a group element
BC with member elements B and C;
      end;
end;
```

Pseudo code for transforming a source datum or database from a flattened XML document into a relational database model into, e.g., up translating, can, for example, be similar to the following:

```
Begin
  Let xml = replicate of flattened XML document;
  Call Restructure XML with xml;
  Return xml
End
Function: Restructure XML
Begin
    For each sibling XML element e with one IDREF attribute idref do
    begin
      Locate sibling element e' with ID referred by idref;
      Move e as child element of e';
      Remove attribute idref from element e;
    End
End
```

FIG. 2 is a diagram 200 that illustrates cross model datum access with semantic preservation between a plurality of different database models in accordance with an aspect of the disclosed subject matter. As disclosed hereinabove, for simplicity and clarity, only four database models are illustrated, although any database model can be employed without departing from the scope of the present disclosure. The four example database models include a relational database model 270 for a relational database in a table structure, an object-oriented database model 272 for an object-oriented database in a class structure, an XML database model 274 for an XML database in a tree structure, and a network database model 276 for a network database in a network structure. However, other database models can be employed, for example, a hierarchical database model 278. Further, as disclosed, translation between these database models can be through an interim database model, such as a flattened XML database model, e.g., flattened XML document(s) 280. Without use of the interim database model, translation between the example database models, e.g., 270, 272, 274, 276, 278, etc., would be by way of programs that effect translation via the outer ring structure illustrated in FIG. 2, e.g., 5*5=25 programs. In contrast, the use of the interim database model, e.g., 280, can instead employ only 5+5=10 programs for data conversion by way of the inner star-shaped structure illustrated in FIG. 2.

Turning now to FIG. 3, presented is a diagram 300 illustrating cross model datum access with semantic preservation with a one-to-many cardinality semantic in accordance with an aspect of the disclosed subject matter. Diagram 300 includes graphical representations of 1:n cardinality for each of the four exemplary database models, e.g., relational, network, object-oriented, and XML. As will be appreciated by one of skill in the relevant art, diagram 300 further comprises pseudo code representations of the four exemplary database models or schema, along with tabular representations or XML document representation below the graphical representations. Further explanation is not herewith presented for the sake of brevity and in view of the generally cumulative nature of the information presented in FIG. 3 in combination with the subject matter presented herein in detail as part of the detailed description.

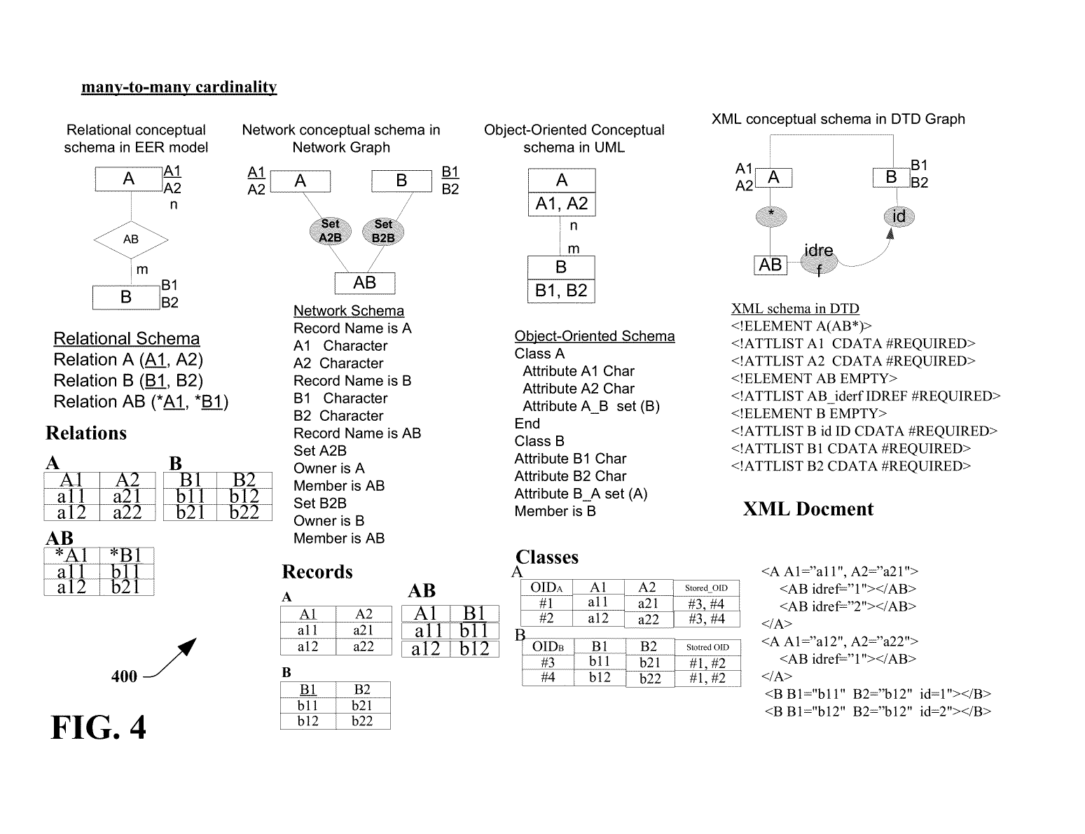

FIG. 4 is a diagram 400 illustrating cross model datum access with semantic preservation with a many-to-many cardinality semantic in accordance with an aspect of the disclosed subject matter. Diagram 400 includes graphical representations of m:n cardinality for each of the four exemplary database models, e.g., relational, network, object-oriented, and XML. As will be appreciated by one of skill in the relevant art, diagram 400 further comprises pseudo code representations of the four exemplary database models or schema, along with tabular representations or XML document representation below the graphical representations. Further explanation is not herewith presented for the sake of brevity and in view of the generally cumulative nature of the information presented in FIG. 4 in combination with the subject matter presented herein in detail as part of the detailed description.

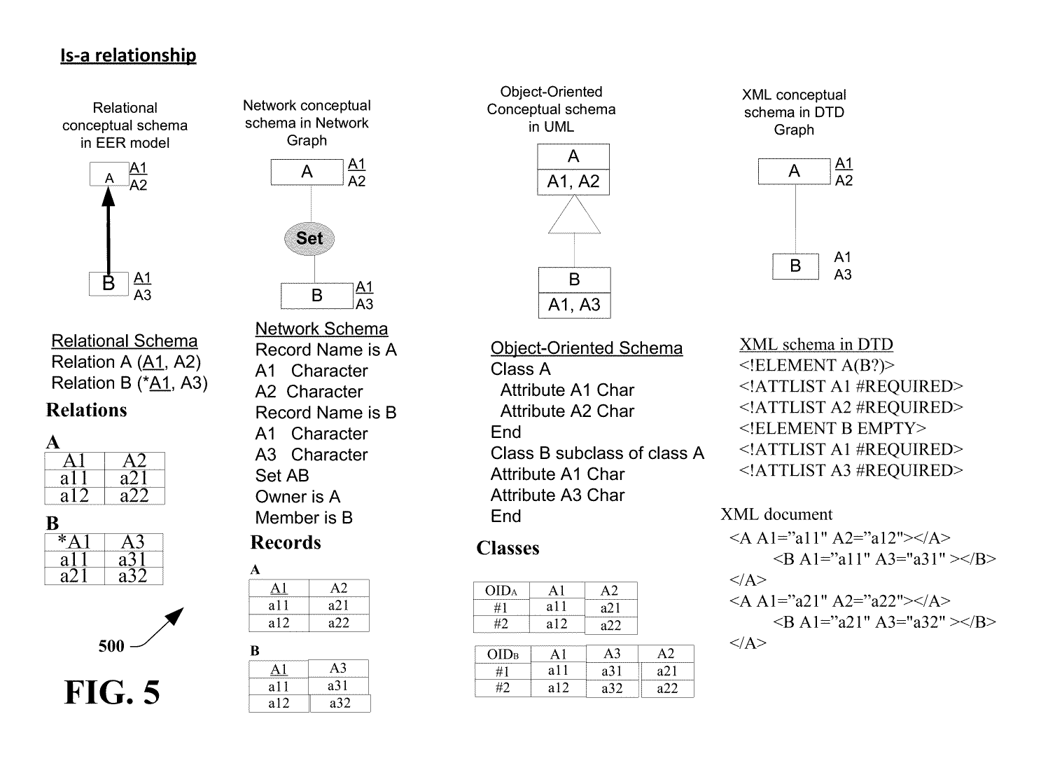

Turning to FIG. 5, is a diagram illustrating cross model datum access with semantic preservation with an is-a relationship semantic in accordance with an aspect of the disclosed subject matter. Diagram 500 includes graphical representations of “is-a” relationships for each of the four exemplary database models, e.g., relational, network, object-oriented, and XML. As will be appreciated by one of skill in the relevant art, diagram 500 further comprises pseudo code representations of the four exemplary database models or schema, along with tabular representations or XML document representation below the graphical representations. Further explanation is not herewith presented for the sake of brevity and in view of the generally cumulative nature of the information presented in FIG. 5 in combination with the subject matter presented herein in detail as part of the detailed description.

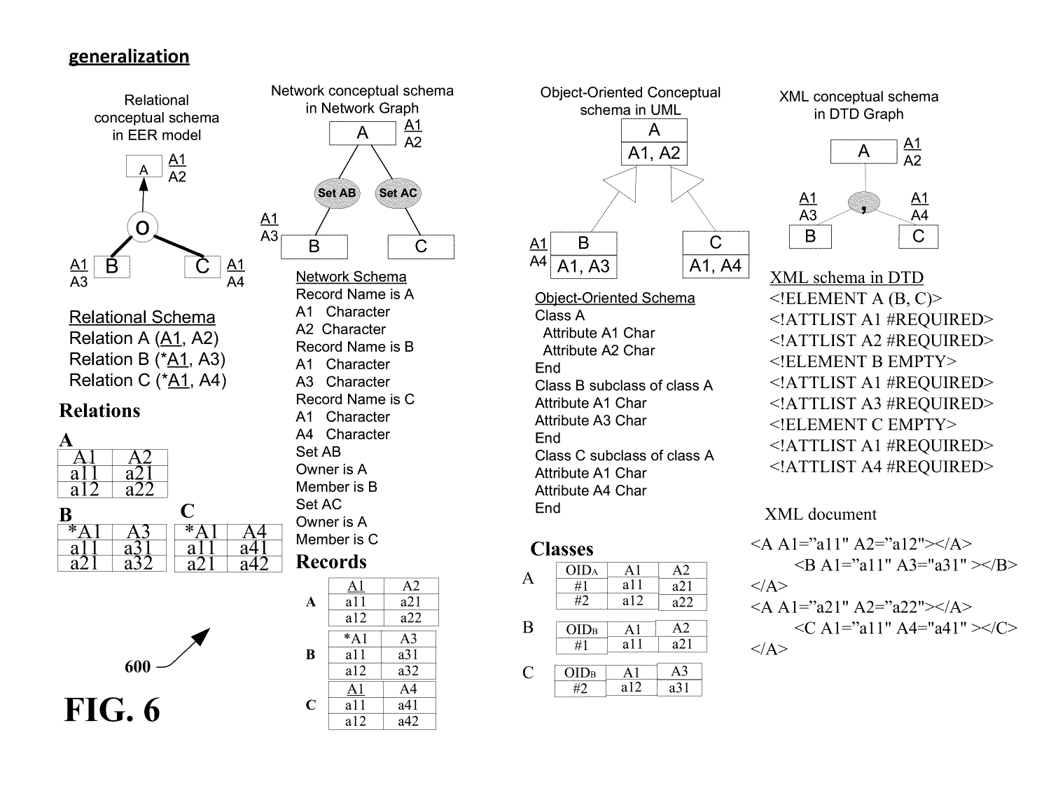

FIG. 6, is a diagram illustrating cross model datum access with semantic preservation with a generalization semantic in accordance with an aspect of the disclosed subject matter. Diagram 600 includes graphical representations of a “generalization” relationship for each of the four exemplary database models, e.g., relational, network, object-oriented, and XML. As will be appreciated by one of skill in the relevant art, diagram 600 further comprises pseudo code representations of the four exemplary database models or schema, along with tabular representations or XML document representation below the graphical representations. Further explanation is not herewith presented for the sake of brevity and in view of the generally cumulative nature of the information presented in FIG. 6 in combination with the subject matter presented herein in detail as part of the detailed description.

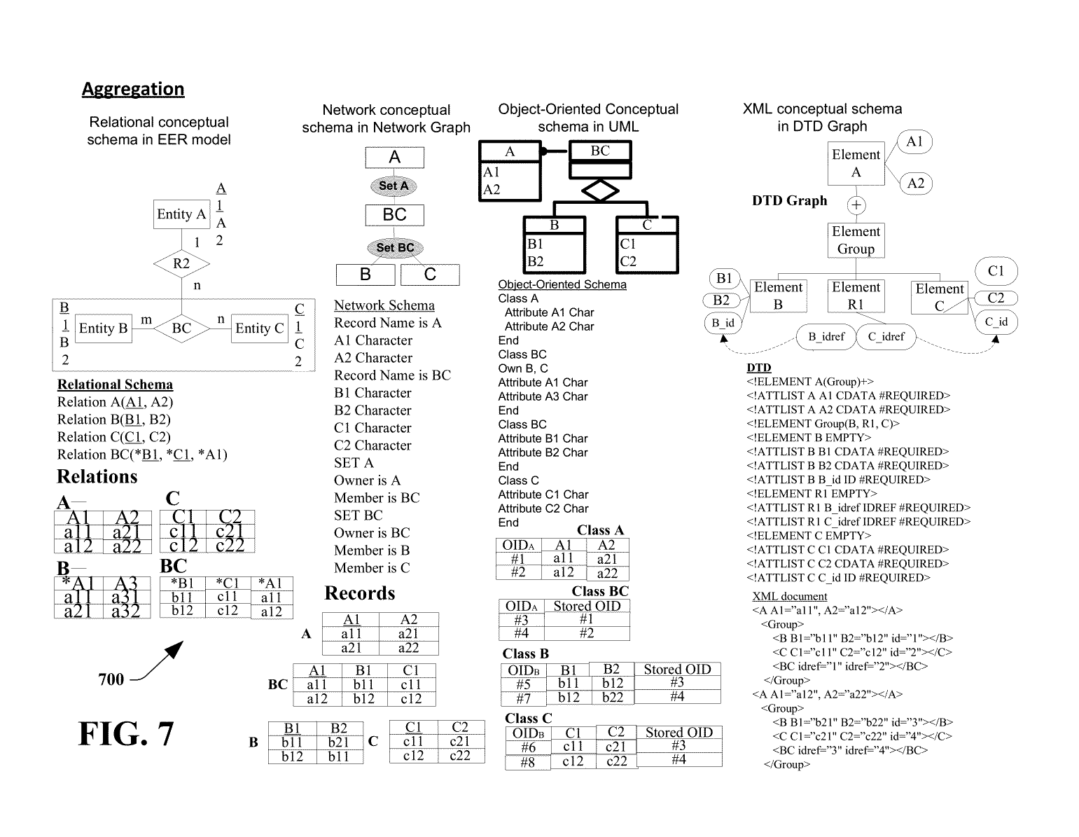

Turning to FIG. 7, is a diagram illustrating cross model datum access with semantic preservation with an aggregation semantic in accordance with an aspect of the disclosed subject matter. Diagram 700 includes graphical representations of an “aggregation” relationship for each of the four exemplary database models, e.g., relational, network, object-oriented, and XML. As will be appreciated by one of skill in the relevant art, diagram 700 further comprises pseudo code representations of the four exemplary database models or schema, along with tabular representations below the graphical representations. Further explanation is not herewith presented for the sake of brevity and in view of the generally cumulative nature of the information presented in FIG. 7 in combination with the subject matter presented herein in detail as part of the detailed description.

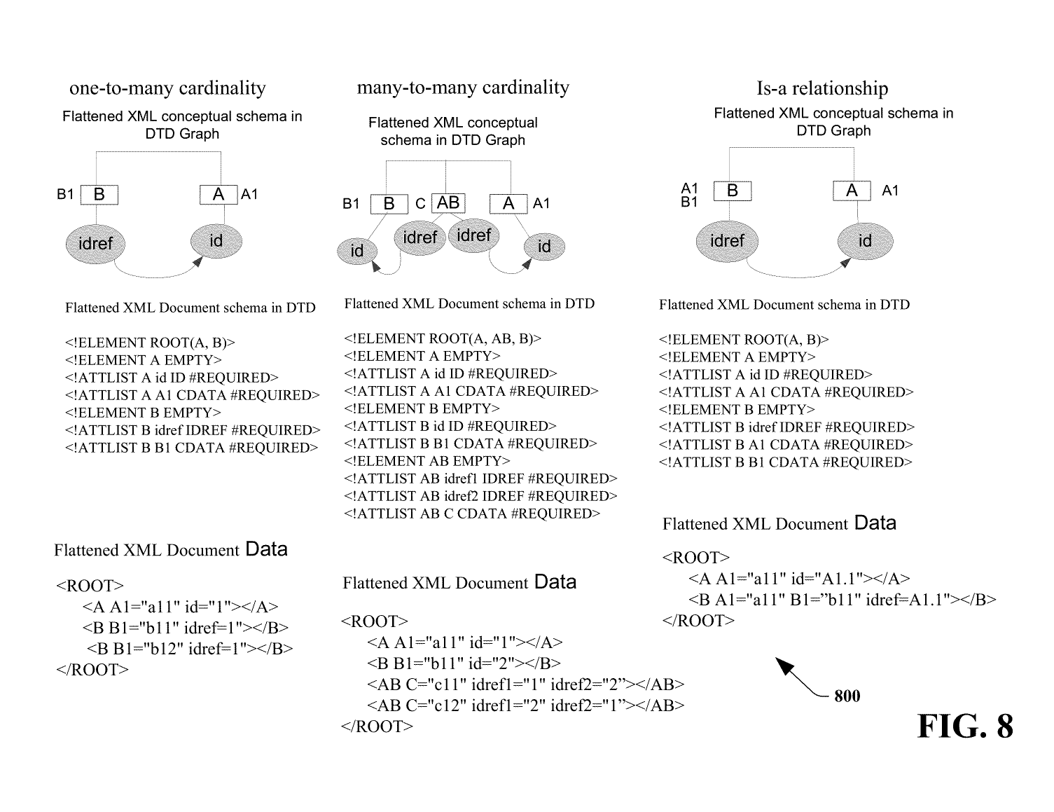

FIG. 8 is a diagram 800 illustrating aspects of cross model datum access with semantic preservation for several semantics, e.g., 1:n, m:n, and “is-a”, in a flattened XML scheme in accordance with an aspect of the disclosed subject matter. Diagram 800 includes graphical representations of a “1:n” relationship, a “m:n” relationship, and a “is-a” relationship, for a flattened XML database model, e.g., where the flattened XML database model is employed as the interim database model as disclosed hereinabove. As will be appreciated by one of skill in the relevant art, diagram 800 further comprises pseudo code representations of the related database models, along with a corresponding flattened XML document representation, below the graphical representations. Further explanation is not herewith presented for the sake of brevity and in view of the generally cumulative nature of the information presented in FIG. 8 in combination with the subject matter presented herein in detail as part of the detailed description.

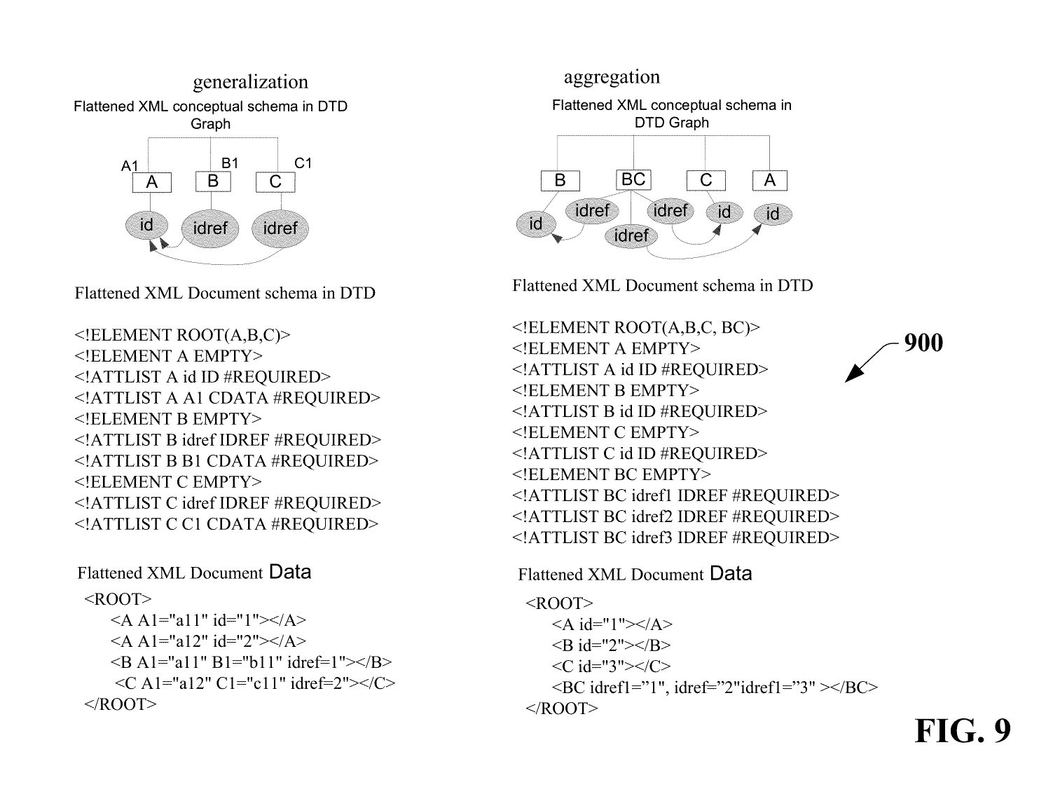

FIG. 9 is a diagram 900 illustrating aspects of cross model datum access with semantic preservation for several additional semantics, e.g., “generalization” and “aggregation”, in a flattened XML scheme in accordance with an aspect of the disclosed subject matter. Diagram 900 includes graphical representations of a “generalization” relationship, and a “aggregation” relationship, for a flattened XML database model, e.g., where the flattened XML database model is employed as the interim database model as disclosed hereinabove. As will be appreciated by one of skill in the relevant art, diagram 900 further comprises pseudo code representations of the related database models, along with a corresponding flattened XML document representation, below the graphical representations. Further explanation is not herewith presented for the sake of brevity and in view of the generally cumulative nature of the information presented in FIG. 9 in combination with the subject matter presented herein in detail as part of the detailed description.

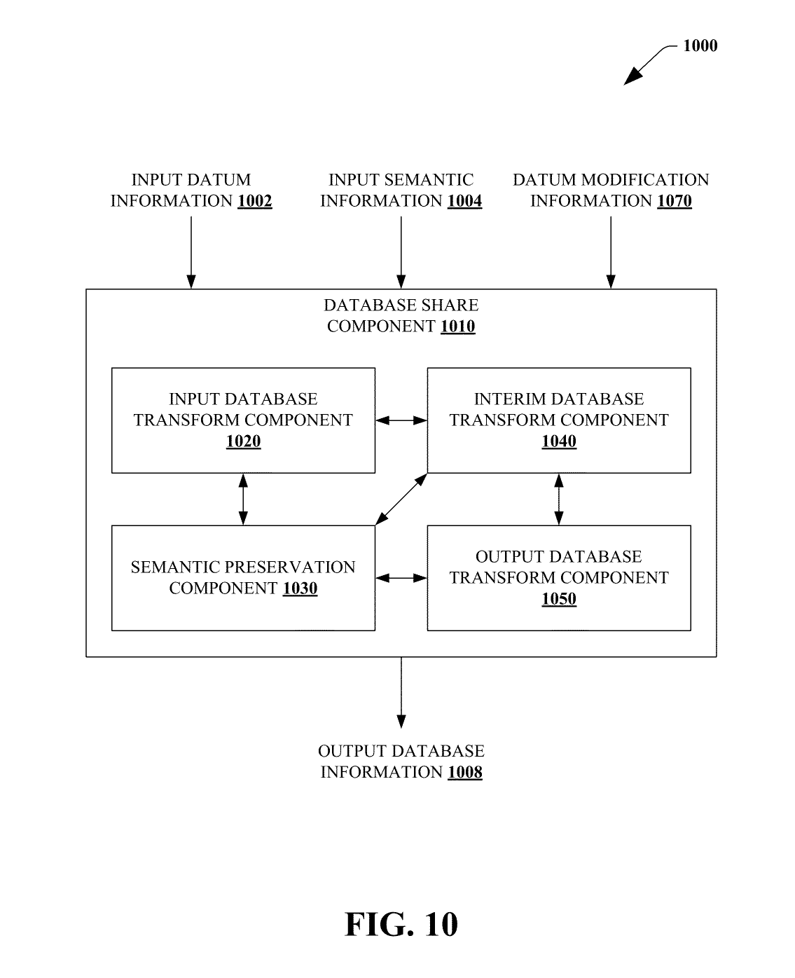

Turning now to FIG. 10, illustrated is an exemplary system 1000 that can facilitate cross model datum access with semantic preservation based on datum modification information in accordance with an aspect of the disclosed subject matter. System 1000 can comprise database share component 1010, that can receive input datum information 1002 and input semantic information 1004. Database share component 1010 can generate output database information 1008. Database share component 1010 can facilitate cross model datum access with semantic preservation, e.g., can receive input datum information 1002 in a first database silo, down translate to an interim database preserving semantic information related to the first database silo, up translate to a second database silo, again preserving semantic information, and make the up translated information available as output database information 1008. In an aspect, the database model of the first database silo can be different from the interim database model or the database model associated with the output database information 1008. Database share component 1010 can comprise database transform component 1020, semantic preservation component 1030, interim database transform component 1040, and output database transform component 1050.

Database transform component 1020 can enable down translation of source data, e.g., source datum included in input datum information 1002. In an embodiment, database transform component 1020 can comprise database model modules or components, not illustrated, that can relate to down translation of a first datum to a second datum. In an aspect, down translation can be based on a source database model and an interim database model.

Semantic preservation component 1030 can enable preservation of semantic information during down translation or up translation. In an embodiment, input semantic information 1004 can comprise semantic information related to a datum, e.g., the datum included in input datum information 1002, to be transformed by database share component 1010. This semantic information can be translated by semantic preservation component 1030 such that semantic information associated with a datum can be preserved between the input datum information 1002 and the output database information 1008. As an example, a one-to-many cardinality for a datum can be preserved in a down translation from a relational database model to a flat XML model and again preserved in an up translation from the flat XML model to an object oriented database model for a datum undergoing translation.

Interim database transform component 1040 can provide information related to the interim database model to input database transform component 1020 to facilitate down translation and to output database transform component 1050 to facilitate up translation. In some embodiments, interim database transform component 1040 can comprise an interim data storage device housing an interim database. As an example, interim database transform component 1040 can house a flattened XML document and information related to a flattened XML database model, such that an input datum included in input datum information 1002 can be down translated by input database transform component 1020 and stored in the flattened XML document while preserving the semantic information included in input semantic information 1004 via semantic preservation component 1030.

Output database transform component 1050 can enable up translation of a datum employing an interim database model to a datum employing a destination database model. This up translated datum can be made accessible via output database information 1008. Further, the semantic information can be preserved in the up translation via semantic preservation component 1030.

Database share component 1010 can further receive datum modification information 1070. Datum modification information 1070 can comprise information indicating a modification event for a datum in a source database. As such, in an embodiment, when a source datum is updated, this event can trigger down translation of the modified datum from the source database to the interim database. In another embodiment, a modification indication can be employed to prioritize down translation of a source datum into an interim database. As an example, datum modification information 1070 can comprise a set of identifiers of modified datum and a time stamp for their modifications, such that their down translation can be prioritized by the age of the modification. In other embodiments, datum modification information 1070 can comprise priority indicators to allow prioritization based on factors like data type, data identification, etc. As an example, pricing data can have a higher down translation priority than quantity available data, such that even though a pricing datum change is younger than a quantity available datum change, the pricing datum change can be assigned a higher priority and be down translated before the quantity available datum.

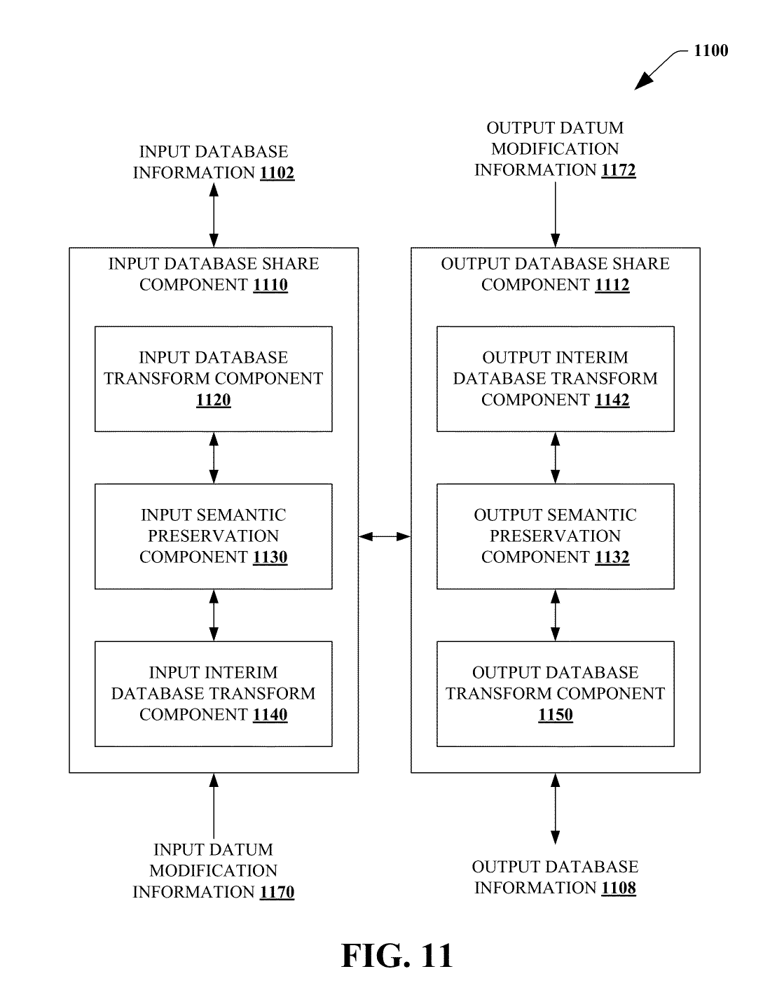

FIG. 11, illustrates a system 1100 that can facilitate bidirectional cross model datum access with semantic preservation in accordance with an aspect of the subject matter disclosed herein. System 1100 can comprise database share component 1110 that can receive input database information 1102. Database share component 1110 can facilitate cross model datum access with semantic preservation, e.g., can receive input database information 1102 in a first database silo and down translate to an interim database preserving semantic information related to the first database silo. System 1100 can further comprise database share component 1112 that can generate output database information 1108. Database share component 1112 can facilitate cross model datum access with semantic preservation, e.g., can receive interim database information, up translate to a second database silo preserving semantic information, and make the up translated information available as output database information 1108. In an aspect, the database model of the first database silo, related to input database 1102, can be different from the interim database model. Further, the interim database model can be different from the database model associated with the output database information 1108. Database share component 1110 can comprise input database transform component 1120, input semantic preservation component 1130, and input interim database transform component 1140. Database share component 1112 can comprise output database transform component 1150, output semantic preservation component 1132, and output interim database transform component 1142.

Input database transform component 1120 can enable down translation from a source database datum and up translation from an interim database datum. In an embodiment, database transform component 1120 can comprise database model modules or components, not illustrated, that can relate to down translation or up translation. As an example, input database information 1102 can comprise a datum from a source database employing a relational database model. Database transform component 1120 can down translate the relational database datum into a flat XML datum where the interim database employs a flat XML model. The flat XML datum can then be up translated by other components, e.g., output database transform component 1150, etc., to a hierarchical database model datum that can be made accessible as part of output database information 1108. Input database transform component 1120 can also operate in a reverse direction allowing up translation of an interim database datum into a source database datum. As an example, database transform component 1120 can up translate a flat XML datum where the interim database employs a flat XML model into a relational database datum where the source database employs a relational database model. This bidirectional translation can enable changes made in a source database to be pushed to an interim database for further translation into a destination database, as well as, changes made in an interim database to be populated back to a source database, both with preservation of semantic relationships.

Input semantic preservation component 1130 can enable preservation of semantic information during down translation or up translation. In an embodiment, input database information 1102 can further comprise semantic information related to a datum to be down translated by database share component 1110, e.g., via database transform component 1120. Similarly, in an embodiment, interim database information, not illustrated, can further comprise semantic information related to a datum to be up translated by database share component 1110, e.g., via database transform component 1120. This semantic information can be translated by semantic preservation component 1130 such that semantic information associated with a datum can be preserved between the input database information 1102 and the output database information 1108 via an interim database model.

Input interim database transform component 1140 can enable input database share component 1110 to interact with an interim database and interim database model or scheme. Input database information 1102 can include a source datum that can be down translated into an interim datum of an interim database and corresponding model which are accessible via input interim database transform component 1140. In an embodiment, input interim database transform component 1140 can comprise the interim database and scheme information. In the reverse direction, input interim database transform component 1140 can facilitate access to an interim datum of an interim database, enabling input database share component 1110 to up translate the interim datum into a source datum for a source database via input database information 1102. As such, input interim database transform component 1140 supports bidirectional transformations of data between a source and interim database.

Output database transform component 1150 can be similar to input database transform component 1120 but operate bi-directionally between an interim database and destination database. Output database transform component 1150 can enable up translation from an interim database datum and down translation from a destination database datum via output database information 1108. In an embodiment, output database transform component 1150 can comprise database model modules or components, not illustrated, that can relate to down translation or up translation. Output database transform component 1150 can operate in a forward direction allowing up translation from an interim database datum to a destination database datum. Output database transform component 1150 can also operate in a reverse direction allowing down translation of a destination database datum into an interim database datum. This bidirectional translation can enable changes made in a destination database to be pushed to an interim database for further translation into a source database, as well as, changes made in an interim database to be populated into to a destination database, both with preservation of semantic relationships.

Output semantic preservation component 1132 can enable preservation of semantic information during down translation or up translation. In an embodiment output semantic preservation component 1132 can be similar to input semantic preservation component 1130. In other embodiments, the interim database model can comprise semantic information related to a datum to be up translated by database share component 1112, e.g., via output database transform component 1150. Similarly, in an embodiment, a destination database datum, received via output database information 1108, can be associated with semantic information related to a datum to be down translated by output database share component 1112, e.g., via output database transform component 1150. This semantic information can be translated by output semantic preservation component 1132 such that semantic information associated with a datum can be preserved between the interim database and the destination database in a bi-directional manner.

Output interim database transform component 1142 can enable output database share component 1112 to interact with an interim database and interim database model or scheme. In an aspect, interim database data can be accessed via output interim database transform component 1142 for up translation, e.g., in a forward direction, by output database transform component 1150. In an embodiment, output interim database transform component 1142 can comprise the interim database and scheme information. In the reverse direction, output interim database transform component 1142 can facilitate access to an interim datum of an interim database, enabling output database share component 1112 to down translate a destination database datum, included in output database information 1108, into an interim database datum. As such, output interim database transform component 1142 supports bidirectional transformations of data between a destination and interim database.

Input database share component 1110 can further receive input datum modification information 1170. Input datum modification information 1170 can comprise information indicating a modification event for a datum in a source database. As such, in an embodiment, when a source datum is updated, this event can trigger down translation of the modified datum, e.g., in the forward direction, from the source database to the interim database. In another embodiment, a modification indication can be employed to prioritize down translation of a source datum into an interim database. In other embodiments, input datum modification information 1170 can comprise priority indicators to allow prioritization based on factors like data type, data identification, etc.

Output database share component 1112 can similarly receive output datum modification information 1172. In an aspect, output datum modification information 1172 can be similar to input datum modification information 1170. Output datum modification information 1172 can comprise information indicating a modification event for a datum in a destination database. As such, in an embodiment, when a destination datum is updated, this event can trigger down translation of the modified datum, e.g., in the reverse direction, from the destination database to the interim database. In another embodiment, a modification indication can be employed to prioritize down translation of a destination datum into an interim database. In other embodiments, output datum modification information 1172 can comprise priority indicators to allow prioritization based on factors like data type, data identification, etc.

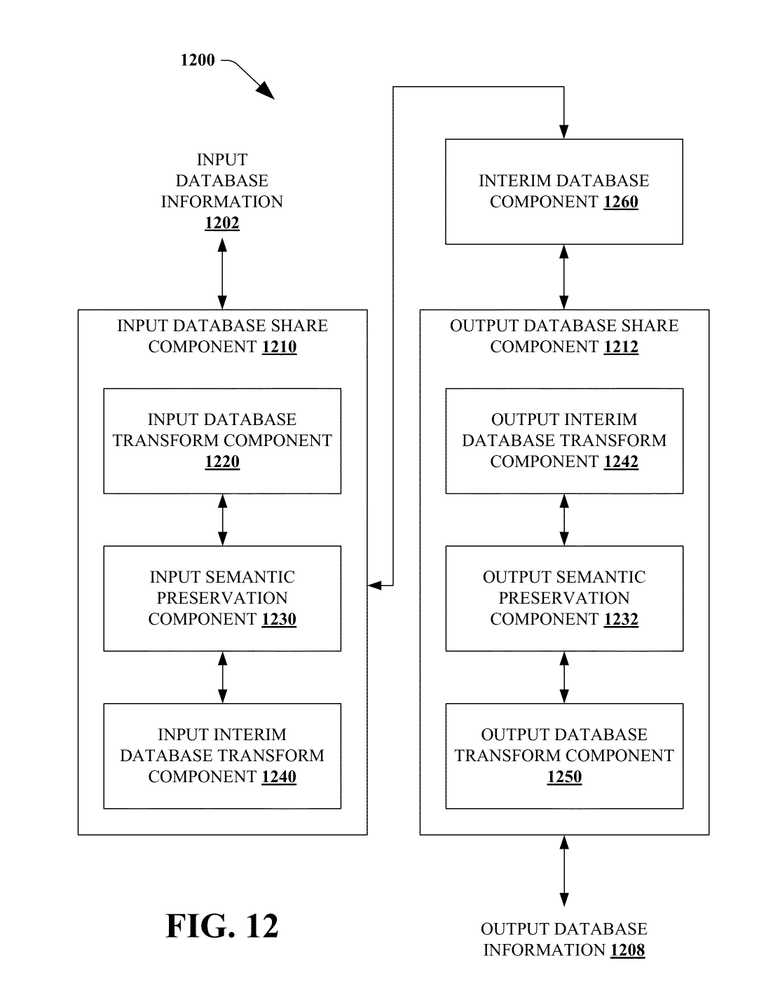

FIG. 12 illustrates a system 1200 that can facilitate cross model datum access with semantic preservation employing an interim database component in accordance with an aspect of the subject matter disclosed herein. System 1200 can comprise database share component 1210 that can receive input database information 1202. Database share component 1210 can facilitate cross model datum access with semantic preservation, e.g., can bi-directionally transform a datum between a source database model and an interim database model. System 1200 can further comprise database share component 1212 that can facilitate cross model datum access with semantic preservation, e.g., can bi-directionally transform a datum between an interim database model and a destination database model. In an aspect, the database model of the source database silo, related to input database information 1202, can be different from the interim database model. Further, the interim database model can be different from the destination database model associated with the output database information 1208. Database share component 1210 can comprise input database transform component 1220, input semantic preservation component 1230, and input interim database transform component 1240. Database share component 1212 can comprise output database transform component 1250, output semantic preservation component 1232, and output interim database transform component 1242.

Input database transform component 1220 can enable bi-directional translation between a source database datum and an interim database datum. In an embodiment, input database transform component 1220 can down translate, from a source datum to an interim datum, or up translate, from an interim datum to a source datum. This bidirectional translation can enable changes made in a source database to be pushed to an interim database, for further translation into a destination database, as well as, enable changes made in an interim database to be populated back to a source database, both with preservation of semantic relationships.

Input semantic preservation component 1230 can enable preservation of semantic information during down translation or up translation. In an embodiment, semantic information can be translated between a source database model and an interim database model by semantic preservation component 1230 such that semantic information associated with a datum can be preserved between the source database the interim database.

Input interim database transform component 1240 can enable input database share component 1210 to interact with an interim database and interim database model or scheme. The interim database and interim database model or scheme can be comprised in interim database component 1260. In an aspect, input interim database transform component 1240 can act as an interface to interim database component 1260 to facilitate access to an interim database and related information. In an embodiment, access can be facilitated bi-directionally, e.g., transforms of source datum can be pushed to an interim database, and further, transforms of interim datum can be pushed to a source database. As such, input interim database transform component 1240 supports bidirectional transformations of data between a source and interim database.

Output database transform component 1250 can be similar to input database transform component 1220 and can operate bi-directionally between an interim database and destination database. This bidirectional translation can enable changes made in a destination database to be pushed to an interim database, as well as, changes made in an interim database can be pushed to destination database, both with preservation of semantic relationships. Output semantic preservation component 1232 can enable preservation of semantic information during down translation or up translation, e.g., via output database transform component 1250. In an embodiment output semantic preservation component 1232 can be similar to input semantic preservation component 1230. Output interim database transform component 1242 can enable output database share component 1212 to interact with an interim database and interim database model or scheme. The interim database and interim database model or scheme can be comprised in interim database component 1260. In an aspect, output interim database transform component 1242 can act as an interface to interim database component 1260 to facilitate access to an interim database and related information. In an embodiment, access can be facilitated bi-directionally, e.g., transforms of destination datum can be pushed to an interim database, and further, transforms of interim datum can be pushed to a destination database. As such, output interim database transform component 1242 supports bidirectional transformations of data between a destination and interim database.

System 1200 can further comprise interim database component 1260. Interim database component 1260 can facilitate access to an interim database employing an interim database model, for example, a flattened XML: document and flattened XML scheme. In an embodiment, interim database component 1260 can comprise a data storage device that can house an interim database and related information. In another embodiment, interim database component 1260 can facilitate a communicative coupling to a remotely stored interim database and related information.

In an aspect, the input database share component 1210, output database share component 1212, and interim database component 1260 can enable various configurations of system 1200. In an embodiment, input database share component 1210, output database share component 1212, and interim database component 1260 can be proximate to each other, e.g., in the same device, in the same office, coupled on an local intranet, etc. In another embodiment, input database share component 1210 can be located locally while output database share component 1212 and interim database component 1260 are co-located remotely, for example, where 1210 is located at a first company and 1212 and 1260 are located at a second company across the country. The converse of this embodiment is also within the scope of the subject disclosure, such that, input database share component 1210 and interim database component 1260 can be co-located locally, while output database share component 1212 is located remotely. In a further embodiment, input database share component 1210 and output database share component 1212 can be co-located locally and interim database component 1260 can be located remotely, for example, where a company translates between two disparate databases locally by accessing an interim database located remotely. In a still further embodiment, input database share component 1210, output database share component 1212, and interim database component 1260 can all be located remotely from each other, e.g., input database share component 1210 can be located at a first location, output database share component 1212 can be located across the country at another location, and interim database component 1260 can also be located remotely from either 1210 or 1212, such as at a location in a foreign country.

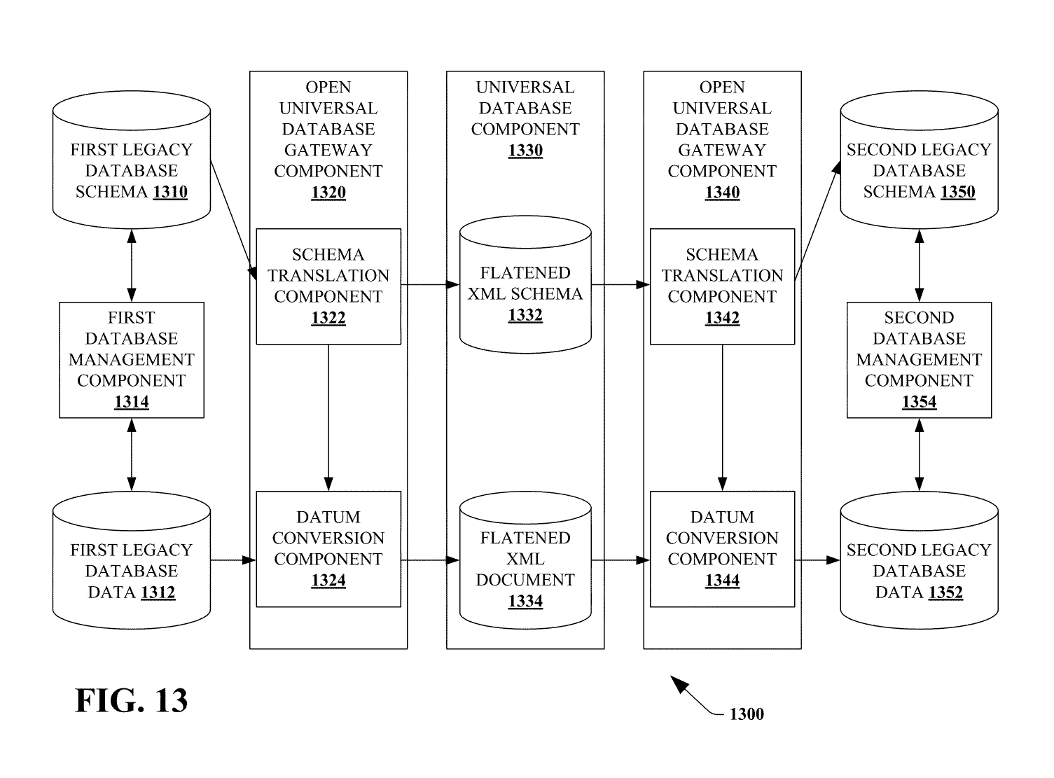

Turning to FIG. 13, illustrated is an example system 1300 that can facilitate cross model datum access with semantic preservation employing a flattened XML scheme and flattened XML document in accordance with an aspect of the disclosed subject matter. Example system 1300 can comprise a first legacy database related to first legacy database schema 1310 and first legacy database data 1312. Example system 1300 can further comprise a second legacy database related to second legacy database schema 1350 and second legacy database data 1352. The first legacy database can be managed by first database management component 1314, while the second legacy database can be managed by second database management component 1354. In example system 1300, translation of data between the first and second legacy databases can be enabled by open universal database gateway (OUDG) component 1320, universal database component 1330 and open universal database gateway (OUDG) component 1340.

OUDG component 1320 can enable translation of a database between a first legacy database and universal database, e.g., an interim database. OUDG component 1320 can comprise schema translation component 1322 that can preprocess first legacy database information to determine a schema and can further preserve data semantics for datum translation between the first legacy database and an interim database. OUDG component 1320 can further comprise datum conversion component 1324 that can translate a datum between a first legacy database and flattened XML document 1334, e.g., an interim database. This translation can preserve related data semantics based on information received from schema translation component 1322.

Universal database component 1330 can enable access to a universal database, e.g., an interim database, related to flattened XML schema 1332 and flattened XML document 1334. Universal database component 1330 can therefore house interim database information to facilitate translation between first legacy database data and second legacy database data, via interim database data, while preserving data semantics.

OUDG component 1340 can enable translation of a database between a second legacy database and universal database, e.g., an interim database. OUDG component 1340 can comprise schema translation component 1342 that can preprocess second legacy database information to determine a schema and can further preserve data semantics for datum translation between the second legacy database and an interim database. OUDG component 1340 can further comprise datum conversion component 1344 that can translate a datum between a second legacy database and flattened XML document 1334, e.g., an interim database. This translation can preserve related data semantics based on information received from schema translation component 1342.

In an aspect, OUDG component 1320, OUDG component 1340, and universal database component 1330 can enable various configurations of system 1300. In an embodiment, any of these components can be located locally to another of these components or located remotely from another of these components, in a manner similar to that disclosed with regard to 1210, 1212, and 1260 of FIG. 12. Furthermore, components 1320, 1330, and 1340 can be located locally with, or remotely from, either, or both, of the first legacy database, e.g., 1310 and/or 1312, or the second legacy database, e.g., 1350 and 1352.

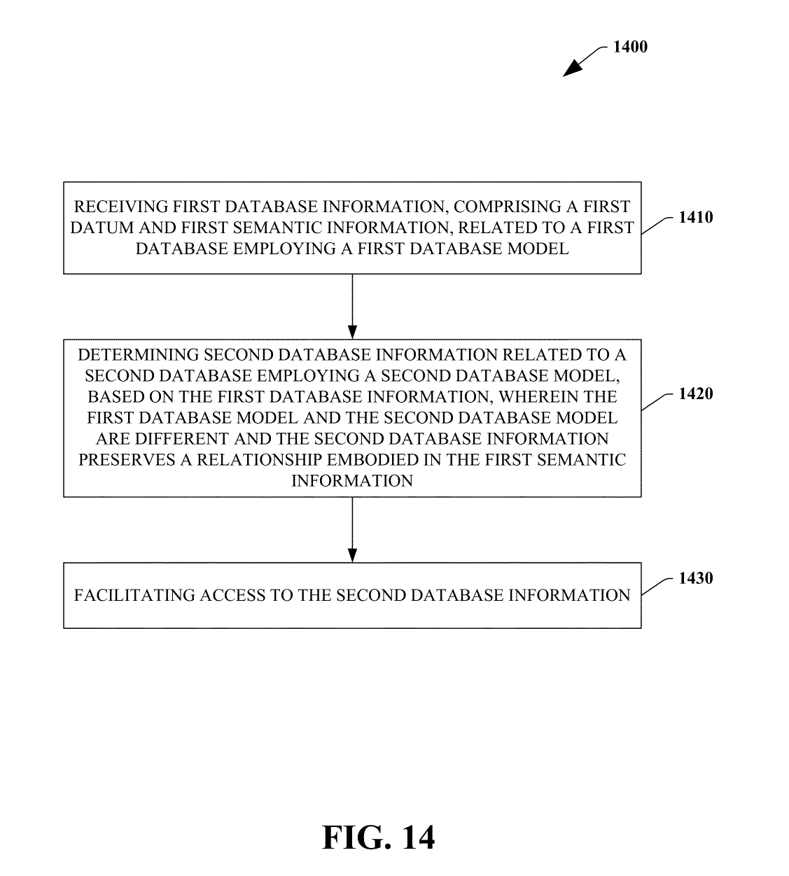

In view of the example system(s) described above, example method(s) that can be implemented in accordance with the disclosed subject matter can be better appreciated with reference to flowcharts in FIG. 14-FIG. 16. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a non-transitory computer-readable medium) to allow transporting and transferring such methods to computers for execution, and thus implementation, by a processor or for storage in a memory.

FIG. 14 illustrates a method 1400 that facilitates cross model datum access with semantic preservation in accordance with an aspect of the disclosed subject matter. As a result, users can access each other's databases via an interim database environment that preserves semantic information from a corresponding database environment. This can let users apply their own familiar query language to access databases employing other database models, for example, SQL can be employed to access an object-oriented database, a network database, or a XML database. Similarly, use OQL, IDMS, or XQuery can be employed to access data in other database silos. Furthermore, an interim database environment can act as a replicate of a source database environment with preservation of the first database and related semantics, to allow the continued use of the source database in parallel with other use of the destination database environment. Moreover, changes can be pushed back to the source database environment via the interim database environment by down translating changes at the destination database into the interim database then up translating into the source database from the interim database.

At 1410, method 1400 can comprise, receiving first database information. First database information can comprise a first datum and first semantic information. These can be related to a first database employing a first database model or scheme. First semantic information can be related to a relationship of the first datum in the first database environment. This relationship can be preserved throughout translation processes that convert the first datum into a second datum in accord with another database model, e.g., as the first datum is converted to a datum in another database model, the new datum can be subject to the same relationships in the second database model as it had under the first database model. For simplicity and clarity, only four database models are illustrated, with regard to the source or destination database model, herein at any substantial length, although any database model can be employed without departing from the scope of the present disclosure. The four example database models include, a network database model for a network database in a network structure, a relational database model for a relational database in a table structure, an XML database model for an XML database in a tree structure, and an object-oriented database model for an object-oriented database in a class structure: However, other database models can be employed, for example, a hierarchical database model, such as illustrated in FIG. 2 at 278.

At 1420, second database information can be determined. The second database information can be related to a second database employing a second database model. The determination can also be based on the first database model, e.g., the first and second database models can be employed in determining the second database information, for example, identifying the proper conversion code to convert a datum between the two database models, identifying semantic information conversion code, etc. Further, the first and second database models can be different database models. Moreover, the second database information can comprise a second datum that preserves a relationship embodied in the first semantic information, from 1410, in relation to the first datum.

At 1430, access to the second database information can be facilitated. At this point, method 1400 can end. Facilitating access can comprise pushing a second datum of the second database information into a second, or destination, database. This can be similar to facilitating access to output database information 108, etc.

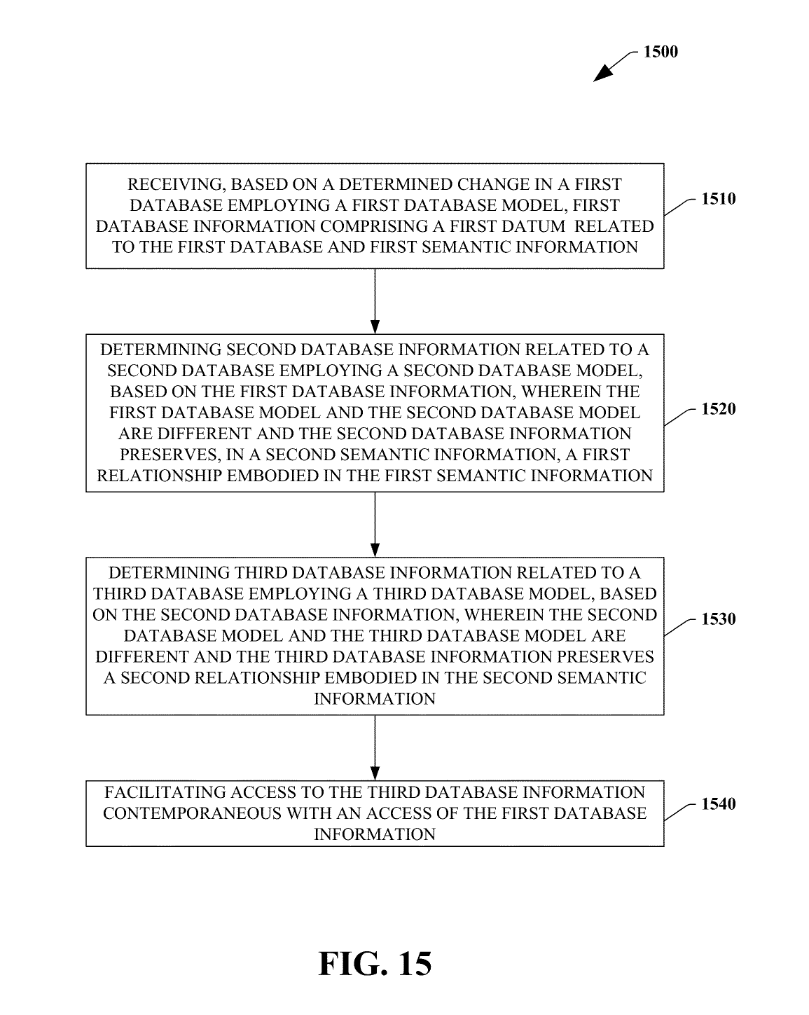

FIG. 15 illustrates a method 1500 that facilitates cross model datum access with semantic preservation, based on a determined change, in accordance with an aspect of the disclosed subject matter. At 1510, method 1500 can comprise, receiving first database information. This can be similar to first database information at 1410 of method 1400, however, the receiving is predicated on determining a change in a first database employing a first database model. As an example, when a datum is changed in the first database, this can indicate that a change has occurred and can result in method 1500 receiving the first database information. As a further example, where a change is scheduled for the first database, this scheduled change can be employed in determining a change to the first database and result in first database information being received at 1510. First database information can comprise a first datum and first semantic information. These can be related to a first database employing a first database model or scheme. First semantic information can be related to a relationship of the first datum in the first database environment. This relationship can be preserved throughout translation processes that convert the first datum into a second datum in accord with another database model.

At 1520, second database information can be determined. Second database information can be related to a second database employing a second database model or scheme. The determining can be based on the first database model and the second database model, which can be different database models. Further, the second database information can generate second semantic information that can facilitate preservation of a first relationship embodied in the first semantic information. In an aspect, the second database can be treated as an interim database having a second database model, e.g., an interim database model.

At 1530, method 1500 can comprise, determining third database information related to a third database employing a third database model. The third database model can be different from either the first and/or second database models. In an aspect, the third database can be considered a destination database. Moreover, the third database information can enable preservation of the second relationship embodied in the second semantic information from 1520. Further, the third database information can comprise a transformed version of a second datum associated with eh second database, which can be a transformed version of a first datum associated with the first database.

At 1540, access to the third database information can be facilitated. This access can be contemporaneous with an access of the first database information. At this point, method 1500 can end. Contemporaneous access is indicative of the first database and third database being accessible at relatively the same time, for example, where they are maintained in parallel. In this aspect, changes to the first database can be rapidly converted to update the third database and changes to the third database can be pushed back rapidly to the first database to keep them relatively synchronized. As such, a DBMS can access the first database with a first database model and corresponding commands while another DBMS can access correlated data having preserved semantics on the third database having a different database model and corresponding commands. This aspect can be useful where a company want to continue to use a legacy DBMS internally while making their data accessible to other entities that can use a different DBMS.

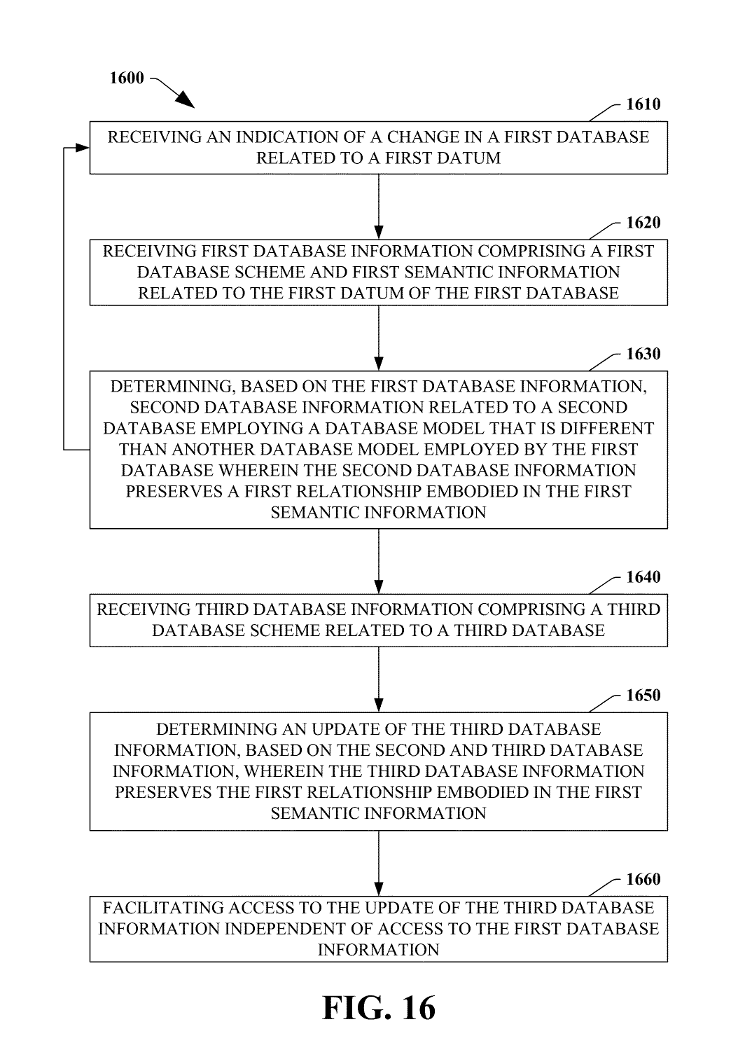

FIG. 16 illustrates a method 1600 that facilitates continuous cross model datum access with semantic preservation in accordance with an aspect of the disclosed subject matter. At 1610, method 1600 can comprise, receiving an indication of a change in a first database related to a first datum. As an example, a change log can indicate that data of the first database has changed. This change log can be employed as an indication of a change occurring in the first database data, identification of what data has changed, the significance of the change with regard to pushing out updates, etc.

At 1620, first database information comprising a first database scheme and first semantic information can be received. The first semantic information can be related to the first datum of the first database. This can be similar to first database information at 1410 of method 1400, but, like 1510 of method 1500, the receiving at 1620 can be in response to receiving an indication of change, e.g., from 1610. As an example, when a datum is changed in the first database, this can indicate that a change has occurred and can result in method 1600 receiving the first database information at 1610. First database information can further comprise the first datum. The relationship described in first semantic information can be preserved across a translation processes that convert the first datum into a second datum that accords with another database model.

At 1630, second database information can be determined. Second database information can be related to a second database employing a second database model or scheme. The determining can be based on the first database model and the second database model, which can be different database models. Further, the second database information can comprise second semantic information that can facilitate preservation of a first relationship embodied in the first semantic information. In an aspect, the second database can be treated as an interim database having a second database model, e.g., an interim database model. At this point, method 1600 can return to 1610 where another change indication is received. Further, at 1630, method 1600 can proceed to 1640.

At 1640, method 1600 can comprise, receiving third database information. Third database information can include a third database model or scheme that can be related to a third database. In an aspect, the third database can be a destination database. Third database information can therefore describe where transformed data can be placed and can thus be used to determine aspects of the transformation needed to place data into the third database. The third database model can be different from either the first and/or second database models. Moreover, the third database information can enable preservation of semantic information from 1620 and 1630.

At 1650, an update to the third database information can be determined. The update can be based on the second and third database information and can preserve the semantics of the first datum. Further, the update to the third database information can comprise a transformed version of the first datum. At 1660, access to the update of the third database information can be facilitated. This access can be independent of access to the first database information. At this point, method 1600 can end. As such, a DBMS can access the first database with a first database model and corresponding commands while another DBMS can access correlated data having preserved semantics on the third database having a third database model and corresponding commands.

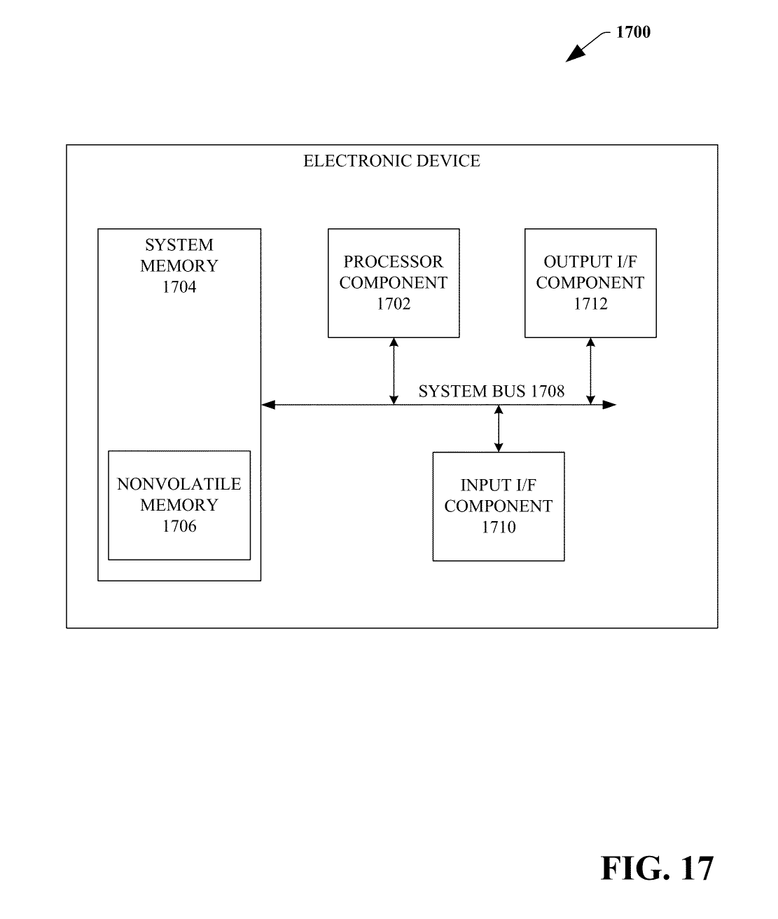

Referring now to FIG. 17, illustrated is a block diagram of an exemplary, non-limiting electronic device 1700 that can facilitate content transcoding in accordance with an aspect of the disclosed subject matter. The electronic device 1700 can include, but is not limited to, a computer, a server, a laptop computer, a server, a dedicated spatial processing component or device, or network equipment (e.g. routers, access points, femtocells, picocells), and the like.

Components of the electronic device 1700 can include, but are not limited to, a processor component 1702, a system memory 1704 (with nonvolatile memory 1706), and a system bus 1708 that can couple various system components including the system memory 1704 to the processor component 1702. The system bus 1708 can be any of various types of bus structures including a memory bus or memory controller, a peripheral bus, or a local bus using any of a variety of bus architectures.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium. Computer-readable storage media can be non-transitory in nature.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The system memory 1704 can include computer-readable storage media in the form of volatile and/or nonvolatile memory 1706. A basic input/output system (BIOS), containing the basic routines that help to transfer information between elements within electronic device 1700, such as during start-up, can be stored in memory 1704. Memory 1704 can typically contain data and/or program modules that can be immediately accessible to and/or presently be operated on by processor component 1702. By way of example, and not limitation, system memory 1704 can also include an operating system, application programs, other program modules, and program data. In some example embodiments, memory 1704 can store database model information, a source datum, a destination datum, an interim datum, processes to transform datum, etc. As an example, an interim database model, source database model, and source datum can be stored in memory 1704. Continuing the example, processor 1702 can process the source datum stored in memory 1704, to determine an interim datum based on the interim database model and the semantics associated with the source database model. The interim datum can then be stored on an interim database for further processing to eventually determine a destination datum while preserving semantic information in accordance with the presently disclosed subject matter.

The nonvolatile memory 1706 can be removable or non-removable. For example, the nonvolatile memory 1706 can be in the form of a removable memory card or a USB flash drive. In accordance with one aspect, the nonvolatile memory 1706 can include flash memory (e.g., single-bit flash memory, multi-bit flash memory), ROM, PROM, EPROM, EEPROM, and/or NVRAM (e.g., FeRAM), or a combination thereof, for example. Further, the flash memory can be comprised of NOR flash memory and/or NAND flash memory.

A user can enter commands and information into the electronic device 1700 through input devices (not illustrated) such as a keypad, microphone, tablet or touch screen although other input devices can also be utilized. These and other input devices can be connected to the processor component 1702 through input interface component 1710 that can be connected to the system bus 1708. Other interface and bus structures, such as a parallel port, game port or a universal serial bus (USB) can also be utilized. A graphics subsystem (not illustrated) can also be connected to the system bus 1708. A display device (not illustrated) can be also connected to the system bus 1708 via an interface, such as output interface component 1712, which can in turn communicate with video memory. In addition to a display, the electronic device 1700 can also include other peripheral output devices such as speakers (not illustrated), which can be connected through output interface component 1712. In an aspect, other electronic devices, e.g., terminal devices can be communicatively coupled to electronic device 1700 by way of input interface component 1710 and output interface component 1712, which can serve to facilitate transfer of transcoded content streams.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

As utilized herein, terms “component,” “system,” “interface,” and the like, can refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Some portions of the detailed description may have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those implicating physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

What has been described above includes examples of aspects of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim. Moreover, the term “or” is intended to be an “inclusive or” and not an “exclusive or”, unless otherwise indicated.

What is claimed is:

1. A system, comprising:
a memory that stores executable instructions; and
a processor, communicatively coupled to the memory, which executes or facilitates execution of the executable instructions to perform operations, comprising:
receiving information related to a first data store;
determining semantic information related to a datum associated with the first data store; and
converting the datum associated with the first data store into a second datum associated with an interim data store, preserving the semantic information in the second datum, based on the information related to the first data store and the semantic information.

2. The system of claim 1, wherein the first data store is a relational schema data store.

3. The system of claim 1, wherein the first data store is an object oriented schema data store.

4. The system of claim 1, wherein the first data store is a network schema data store.

5. The system of claim 1, wherein the first data store is an extensible markup language (XML) schema data store.

6. The system of claim 1, wherein the interim data store is a flattened extensible markup language (XML) schema data store.

7. The system of claim 1, wherein the operations further comprise:
receiving information related to the interim data store; and
converting the second datum associated with the interim data store into a third datum associated with a destination data store, based on the information related to the interim data store.

8. The system of claim 7, wherein the destination data store is a relational schema data store.

9. The system of claim 7, wherein the destination data store is an object oriented schema data store.

10. The system of claim 7, wherein the destination data store is a network schema data store.

11. The system of claim 7, wherein the destination data store is an Extensible Markup Language (XML) schema data store.

12. The system of claim 1, wherein the interim data store is stored on a storage device located locally with regard to the processor.

13. The system of claim 1, wherein the interim data store is stored on a storage device located remotely from the processor.

14. The system of claim 13, wherein information transmitted to the storage device traverses an internet gateway device.

15. The system of claim 1, wherein the operations further comprise:
determining a change of the first datum associated with the first data store; and
triggering the converting the first datum based on the change.

16. A method, comprising:
receiving, by a system including a processor, first information comprising semantic information describing a data relationship related to a first datum associated with a first data store;
receiving, by the system, the first datum; and
translating, by the system, the first datum into a devolved datum associated with an intermediate data store while maintaining the data relationship in the intermediate data store, based on the first information.

17. The method of claim 16, wherein the intermediate data store is a flattened extensible markup language (XML) schema data store.

18. The method of claim 16, further comprising translating the devolved datum associated with the intermediate data store into a destination datum associated with a destination data store while maintaining the data relationship in the destination data store, based on semantic information related to the devolved datum and the intermediate data store.

19. The method of claim 18, wherein the translating the first datum comprises translating the first datum from a relational schema data store, or the translating the devolved datum comprises translating the devolved datum into a destination datum associated with another relational schema data store.

20. The method of claim 18, wherein the translating the first datum comprises translating the first datum from an object oriented schema data store, or the translating the devolved datum comprises translating the devolved datum into a destination datum associated with another object oriented schema data store.

21. The method of claim 18, wherein the translating the first datum comprises translating the first datum from a network schema data store, or the translating the devolved datum comprises translating the devolved datum into a destination datum associated with another network schema data store.

22. The method of claim 18, wherein the translating the first datum comprises translating the first datum from an Extensible Markup Language (XML) schema data store, or the translating the devolved datum comprises translating the devolved datum into a destination datum associated with another XML data store.

23. The system of claim 18, wherein the operations further comprise:
determining a change of the first datum associated with the first data store;
triggering the translating the first datum based on the change; and
triggering the translating the devolved datum in response to the translating the first datum.

24. A non-transitory computer-readable medium storing executable instructions that, in response to execution, cause a device comprising a processor to perform operations, comprising:
receiving information related to a first data store, wherein the information comprises data semantic information describing a data relationship associated with the first data store;
receiving a first datum associated with the first data store;
adapting the first datum into a second datum associated with a second data store, wherein the adapting the first datum preserves the data relationship described by the data semantic information, based on the information related to the first data store; and
adapting the second datum associated with the second data store into a third datum associated with a third data store, wherein the adapting the second datum preserves the data relationship described by the data semantic information, based on information related to the second data store.

25. The non-transitory computer-readable medium of claim 24, wherein the first data store or the third data store is a relational schema data store, an object oriented schema data store, a network schema data store, or an extensible markup language (XML) schema data store.

26. The non-transitory computer-readable medium of claim 24, wherein the second data store is a flattened extensible markup language (XML) schema data store.

27. The non-transitory computer-readable medium of claim 24, wherein the operations further comprise:
determining a change of the first datum associated with the first data store;
triggering the adapting the first datum based on the change; and
triggering the adapting the second datum in response to the adapting the first datum.

28. A system, comprising:
means for receiving a first datum associated with the first data store;
means for adapting the first datum into a second datum associated with a second data store, based on information related to the first data store, the adapting the first datum preserving data semantics associated with a cardinality, an is-a relationship, a generalization relationship, or an aggregation relationship; and
means for adapting the second datum associated with the second data store into a third datum associated with a third data store, based on the information related to the second data store, the adapting the second datum preserving data semantics associated with the cardinality, the is-a relationship, the generalization relationship, or the aggregation relationship.

29. The system of claim 28, wherein the second data store is a flattened extensible markup language (XML) schema data store.

30. The system of claim 28, wherein the first data store or the third data store is a relational schema data store, an object oriented schema data store, a network schema data store, or an extensible markup language (XML) schema data store.
